(19) United States
(12) Patent Application Publication
(10) Pub. No.: US 2021/0402381 A1
(43) Pub. Date: Dec. 30, 2021

(54) RUBBER COMPOSITIONS AND METHODS

(71) Applicant: Fernando Thome Kreutz, Porto Alegre (BR)

(72) Inventors: Fernando Thome Kreutz, Porto Alegre (BR); Diana Exenberger Finkler, Novo Hamburgo (BR); Diego Ivan Petkowicz, Novo Hamburgo (BR)

(21) Appl. No.: 16/636,584

(22) PCT Filed: Aug. 4, 2018
(86) PCT No.: PCT/IB2018/055881

§ 371 Date: Feb. 4, 2020

Related U.S. Application Data
(60) Provisional application No. 62/541,244, filed on Aug. 4, 2017.

(51) Int. Cl. B01J 29/70; C08K 3/06; C08K 9/12; C08K 5/17; C08L 97/00

(52) U.S. Cl. CPC B01J 29/7003; C08K 3/06; C08J 3/24; C08K 5/17; C08L 97/005; C08K 9/12

(57) ABSTRACT

A nanostructured porous catalyst for rubber vulcanization, the catalyst comprising a high surface area.

### FIELD

The present invention relates to elastomeric compositions. In particular, the present invention relates to catalysts and antioxidants for use in rubber vulcanization methods.

### BACKGROUND

Vulcanization is a chemical process for converting elastomeric polymers, including natural rubber, into more durable materials by the addition of a crosslinking agent, such as sulfur, along with other additives tailored to the polymer being used and the desired qualities of the end product. The crosslinking agent modifies the polymers by forming crosslinks between individual polymer chains.

The most common vulcanizing methods depend on sulfur. The number of sulfur atoms, usually between one and eight, in the crosslink influences the physical properties of the final rubber article. Short crosslinks tend to give the rubber better heat resistance. Crosslinks with higher number of sulfur atoms tend give the rubber good dynamic properties but less heat resistance. Sulfur, by itself, is a slow and inefficient vulcanizing agent. Therefore, catalysts (or “accelerators”) are typically used to increase the speed of vulcanization.

Different elastomeric polymers may be more suited to different types of crosslinking agents. For example, the vulcanization of neoprene or polychloroprene rubber is typically carried out using metal oxides rather than sulfur compounds. Like with sulfur compounds, metal oxides are typically used in combination with catalysts to speed up the crosslinking process.

Zeolites are widely used as catalysts in the petrochemical industry, for instance in fluid catalytic cracking and hydrocracking. Zeolites confine molecules in small spaces, which causes changes in their structure and reactivity. The hydrogen form of zeolites (prepared by ion-exchange) are powerful solid-state acids, and can facilitate a host of acid-catalyzed reactions, such as isomerisation, alkylation, and cracking.

U.S. Pat. No. 3,036,986 describes a method for accelerating the curing reaction of a butyl rubber formulation by use of a strong acid. Said strong acid is introduced into the formulation while contained within the pores of a crystalline, zeolitic molecular sieve adsorbent at loading levels of at least 5 wt. %.

U.S. Patent Application Publication No. 2013/0274360 describes a process for preparing a vulcanizable rubber composition comprising at least one elastomeric polymer, at least one phenol formaldehyde resin cross-linker, an activator package, and at least one activated zeolite.

Other additives are also typically included during the vulcanization, such as activators (also catalysts; typically zinc oxide and stearic acid), retarding agents, which inhibit vulcanization until a desired time and/or temperature is reached, and antidegradants, which are used to prevent degradation of the vulcanized product by, for example, heat, oxygen, and ozone.

Antioxidants are one type of antidegradant typically found in rubber compositions. These prevent oxidative degradation and increase the durability of rubber. Lignin is a natural antioxidant and Zaher et al. (Pigment & Resin Technology; 2014; 43(3):159-174) studied the efficiency of lignin/silica and calcium lignate/calcium silicate as natural antioxidants in styrene-butadiene rubber (SBR) vulcanizates. Kai et al. (Green Chemistry; 2016; 18(5):1175-1200) describe advanced lignin modification chemistry that has generated a number of functional lignin-based polymers, which integrate both the intrinsic features of lignin and additional properties of the grafted polymers. These modified lignin and its copolymers display better miscibility with other polymeric matrices, leading to improved performance for these lignin/polymer composites. Zhu et al. (BioResources; 2015; 10(3), 4315-4325) describe the modification of lignin with silane coupling agents to improve the interface of poly(l-lactic) acid/lignin composites.

A need exists for the development of a product, composition and/or method that provides the public with a useful alternative.

### SUMMARY OF THE INVENTION

In accordance with an aspect, there is provided a nanostructured porous catalyst for rubber vulcanization, the catalyst comprising a high surface area.

In an aspect, the catalyst is a zeolite.

In an aspect, the zeolite is selected from the group consisting of ZSM-5, A, X, Y, high silica zeolite, sodalite, modernite, clinoptilolite, faujasite, bentonite, erionite, and combinations thereof.

In an aspect, the catalyst is a mesoporous compound.

In an aspect, the mesoporous compound is selected from the group consisting of SBA-15, MCM-48, SBA-1, SBA-6, SBA-16, FDU-2, KIT-S, MCM-41 and combinations thereof.

In an aspect, the catalyst comprises a crosslinking agent adsorbed to the catalyst.

In an aspect, the crosslinking agent is selected from the group consisting of sulfur, sulfur compounds e.g. 4,4′-dithiomorpholine; organic peroxides e.g. dicumyl peroxide; nitroso compounds e.g. p-dinitrosobenzene, bisazides, polyhydrosilanes, metal oxides bisphenols, such as bisphenol A, and combinations thereof.

In an aspect, the crosslinking agent is sulfur, such as rhombic sulfur.

In an aspect, the catalysts assists in positioning the crosslinking agent near a carbon atom in the rubber.

In an aspect, the catalyst comprises an activator adsorbed to the catalyst.

In an aspect, the activator is a thermally conductive.

In an aspect, the activator is selected from the group consisting of:

Aluminum, Antimony, Beryllium, Bismuth, Cadmium, Calcium, Chromium, Cobalt, Copper, Gold, Iron (α, β, γ, δ), Lead, Magnesium, Manganese (α, β, γ), Mercury (liquid), Molybdenum, Nickel (α, β), Palladium, Platinum, Potassium, Rhodium, Silicon, Silver, Sodium, Thorium, Titanium, Tungsten, Vanadium, Zinc, Al₂O₃, B₂O₃, CaO, Cr₂O₃, CuO, Fe₂O₃, Fe₃O₄, PbO, PbO₂, MgO, NiO, SiO₂ quartz α, SiO₂ quartz R, SiO₂ cristobalite α, SiO₂ cristobalite β, TiO, U₃O₈, ZnO, ZrO₂, AlF₃, CaF₂, KF, NaF, and/or a member of the following table:

| | Condutividade | | Condutividade |
|---|---|---|---|
| Material | térmica (W/mK) | Material | térmica (W/mK) |
| Carbono (nanotubos) | 6000 | Silica (SiO2) | 1.38 |
| Grafite pirolitico | 1500 | Vidro comum | 1.00 |
| (HOPG) | | | |
| Diamante | 1000 | Concreto | 0.800 |
| Prata (Ag) | 426 | Agua | 0.610 |
| Cobre (Cu) | 380 | Polietileno alta | 0.500 |
| | | densidade | |
| Ouro (Au) | 318 | Papel | 0.330 |
| Aluminio (Al) | 230 | Glicerina | 0.284 |
| Carbeto de silicia | 200 | Polipropileno | 0.250 |
| (SiC) | | | |
| Tungstenio (W) | 178 | Teflon | 0.250 |
| Silicio (Si) | 148 | Etilenoglicol | 0.240 |
| Zinco (Zn) | 112 | PVC | 0.200 |
| Latao (70Cu-30Zn) | 109 | PET (Mylar) | 0.176 |
| Niquel (Ni) | 88.00 | Epoxi | 0.160 |
| Ferro (Fe) | 80.30 | Oelo de carnauba | 0.160 |
| Bronze (90Cu, 10Al) | 52.00 | Baquelite | 0.150 |
| Solda estanho/ | 50.21 | Oleo mineral para | 0.144 |
| chumbo (60Sn/40Pb) | | transformadores | |
| Aça | 50.20 | Oleo Lubrax | 0.135 |
| Safira (SiO2) | 41.00 | Maderia (compensado) | 0.120 |
| Chumbo (Pb) | 24.70 | Poliamida (Kapton) | 0.120 |
| Alumina (Ceramica - | 30.00 | Vermiculita | 0.050 |
| Al2O3) | | | |
| Titan io (Ti) | 21.00 | La de vidro ou de | 0.045 |
| | | rocha | |
| Mercurio (Hg) | 8.30 | Feltro | 0.040 |
| Basalto | 3.50 | Poliestireno | 0.040 |
| | | expandid (isopar) | |
| Arenito (Pedra gres) | 1.60 | Cortica | 0.039 |
| Geio | 1.60 | Ar | 0.026 |
| Virdo borossilcato | 1.40 | Poliuretano (espuma) | 0.024 |

In an aspect, the catalyst is free of an adsorbed component.

In an aspect, the rubber is selected from the group consisting of natural rubber (NR), polyisoprene rubber (IR), styrene-butadiene rubber (SBR), polybutadiene rubber (BR), nitrile rubber (NBR), butyl rubber (IIR), brominated isobutylene-isoprene copolymers with bromine contents of 0.1 to 10 wt. % (BIIR), chlorinated isobutylene-isoprene copolymers with chlorine contents of 0.1 to 10 wt. % (CIIR), hydrogenated or partially hydrogenated nitrile rubber (NBR, HNBR, HSN), styrene-butadiene-acrylonitrile rubber (SNBR), styrene-isoprene-butadiene rubber (SIBR), polychloroprene (neoprene) (CR), chlorosulfonated polyethylene (CSM), epichiorohydrin rubber (ECH, ECO), ethylene propylene diene monomer (EPDM), ethylene propylene rubber (EPR), fluoroelastomer (FKM), perfluoroelastomer (FFKM), polyacrylate rubber (ACM), polysulfide rubber (PSR), sanifluor, silicone rubber (SiR), chlorinated polyethylene (CM), and combinations thereof.

In accordance with an aspect, there is provided a rubber composition comprising the catalyst described herein.

In an aspect, the rubber composition is vulcanized.

In an aspect, the rubber composition further comprises lignin.

In an aspect, the lignin is organosilane-modified.

In accordance with an aspect, there is provided a tire comprising the rubber composition described herein.

In accordance with an aspect, there is provided a method of vulcanizing rubber, the method comprising catalyzing the vulcanizing with the catalyst described herein.

In accordance with an aspect, there is provided an antioxidant for rubber vulcanization, the antioxidant comprising an organosilane-modified lignin.

In an aspect, the organosilane modification is selected from the group consisting of:

XIAMETER® OFS-6070 Silane Methyl Methoxy Methyltrimethoxysilane

Dow Corning® 1-6383 Silane Methyl Ethoxy Methyltriethoxysilane

XIAMETER® OFS-6194 Silane Methyl Methoxy Dimethyldimethoxysilane

Dow Corning® Z-6265 Silane Propyl Methoxy Propyltrimethoxysilane

XIAMETER® OFS-2306 Silane i-Butyl Methoxy Isobutyltrimethoxysilane

XIAMETER® OFS-6124 Silane Phenyl Methoxy Phenyltrimethoxysilane

XIAMETER® OFS-6341 Silane n-Octyl Ethoxy n-Octyltriethoxysilane

Dow Corning® Z-6011 Silane Amino Ethoxy Aminopropyltriethoxysilane

XIAMETER® OFS-6020 Silane Amino Methoxy Aminoethylaminopropyltrimethoxysilane

XIAMETER® OFS-6094 Silane Amino Methoxy Aminoethylaminopropyltrimethoxysilane (high purity)

Dow Corning® Z-6137 Silane Amino-Aminoethylaminopropylsiloxane oligomers (aq) XIAMETER® OFS-6032 Silane Vinyl-benzyl-amino Methoxy Vinylbenzylated aminoethylaminopropyltrimethoxysilane

XIAMETER® OFS-6224 Silane Vinyl-benzyl-amino Methoxy Low CI version of XIAMETER® OFS-6032 Silane

Dow Corning® Z-6028 Silane Benzylamino Methoxy Benzylated-aminoethylaminopropyltrimethoxysilane

XIAMETER® OFS-6030 Silane Methacrylate Methoxy g-Methacryloxypropyltrimethoxysilane XIAMETER® OFS-6040 Silane Epoxy Methoxy g-Glycidoxypropyltrimethoxysilane

XIAMETER® OFS-6076 Silane Chloropropyl Methoxy g-Chloropropyltrimethoxysilane

Dow Corning® Z-6376 Silane Chloropropyl Ethoxy g-Chloropropyltriethoxysilane

Dow Corning® Z-6300 Silane Vinyl Methoxy Vinyltrimethoxysilane

XIAMETER® OFS-6075 Silane Vinyl Acetoxy Vinyltriacetoxysilane

Dow Corning® Z-6910 Silane Mercapto Ethoxy Mercaptopropyltriethoxysilane

XIAMETER® OFS-6920 Silane Disulfido Ethoxy Bis-(triethoxysilylpropyl)-disulfide

XIAMETER® OFS-6940 Silane Tetrasulfido Ethoxy Bis-(triethoxysilylpropyl)-tetrasulfide

Dow Corning® Z-6675 Silane Ureido Methoxy g-Ureidopropyltriethoxysilane

XIAMETER® OFS-6106 Silane Epoxy/melamine Methoxy Epoxy silane modified melamine resin

Bis[3-(triethoxysilyl)propyl]polysulide (Si69®)

| 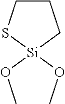 | Sulfur Functional Silanes - Trialkoxy SID3454.0 2,2-DIMETHOXY-1-THIA-2-SILACYCLOPENTANE C₅H₁₂O₂SSi 164.29 57-8°/7 1.094 Reagent for modification of silver and gold surfaces Coupling agent for rubber [26903-85-5] HMIS: 3-3-1-X 25 g | | | | |
|---|---|---|---|---|---|
| 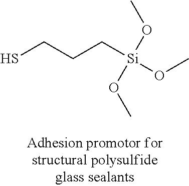 | SIM6476.0 3-MERCAPTOPROPYLTRIMETHOXYSILANE C₆H₁₆O₃SSi 196.34 93°/40 1.051²⁵ 1.4502²⁵ Viscosity: 2 cSt Flashpoint: 96° C. (205° F.) yc of treated surfaces: 41 mN/m TOXICITY: oral rat, LD50: 2,380 mg/kg Specific wetting surface: 348 m²/g Primary irritation index: 0.19 Coupling agent for EPDM and mechanical rubber applications Adhesion promoter for polysulfide adhesives For enzyme immobilization.¹ Treatment of mesoporous silica yields highly efficient heavy metal scavenger.² Couples fluorescent biological tags to semiconductor CdS nanoparticles.³ Modified mesoporous silica supports Pd in coupling reactions.⁴ | | | | |
| | Used to make thiol-organosilica nanoparticles.⁵ | | | | |
| | Forms modified glass and silica surfaces suitable for SILAR fabrication of CdS | | | | |
| | thin films.⁶ | | | | |
| | 1. Stjernlof, P. et al. Tetrahedron Lett. 1990, 31, 5773. | | | | |
| | 2. Liu, J. et al. Science 1997, 276, 923. | | | | |
| | 3. Bruchez, M. et al. Science 1998, 281, 2013. | | | | |
| | 4. Crudden, C. et al. J. Am. Chem. Soc. 2005, 127, 10045. | | | | |
| | 5. Nakamura, M; Ishimura, K. Langmuir 2008, 24, 5099. | | | | |
| | 6. Sun, H. et al. Dispersion Sci. Technol. 2005, 26, 719. | | | | |
| | [4420-74-0] | TSCA EC 224-588- | 100 g | 2 kg | 18 kg |
| | | 5 HMIS; 3-2-1-X | | | |

| 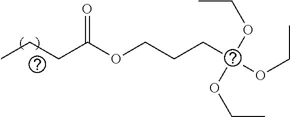 | SIO6704.0 S-(OCTANOYL)MERCAPTOPROPYLTRIETHOXYSILANE C₁₇H₃₆O₄SSi 364.62 0.9686 1.4515 Flashpoint: 176° C. (349° F.) TOXICITY: oral rat, LD50: >2,000 mg/kg Masked mercaptan - deblocked with alcohols Latent coupling agent for butadiene rubber [220727-26-4] TSCA HMIS: 2-2-1-X 25 g 100 g 18 kg | | | | |
|---|---|---|---|---|---|
| 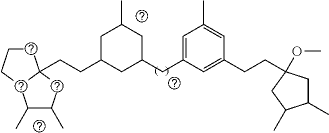 | Sulfur Functional Silanes - Dipodal SIB 1820.5 BIS[m-(2-TRIETHOXYSILYLETHYL)TOLYL]POLYSULFIDE, tech-90 C₃₀H₅₀O₆S(₂₋₄)Si₂ 627-691 1.10 1.533 Dark, viscous liquid Flashpoint: 55° C. (131° F.) Coupling agent for SBR rubber [198087-81-9]/[85912- TSCA HMIS: 2- 25 g 2 kg 75-0]/[67873-85-2 2-1-X | | | | |
| 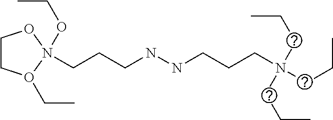 | SIB1824.6 BIS[3-(2-TRIETHOXYSILYL)PROPYL]DISULFIDE, 90% BIS(TRIETHOXY- SILYL)-4,5-DITHIOOCTANE C₁₈H₄₂O₆S₂Si₂ 474.82 1.025 1.457 Contains sulfide and tetrasulfide Flashpoint: 75° C. (167° F.) Dipodal coupling agent/vulcanizing agent for rubbers Intermediate for mesoporous silicas with acidic pores.¹ 1. Alauzan, J. et al. J. Am. Chem. Soc. 2006, 128, 8718. | | | | |
| | [56706-10-6] | TSCA EC 260- | 25 g | 100 g | 2 kg |
| | | 350-7 HMIS:2- | | | |
| | | 2-1-X | | | |

| 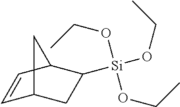 [SMILES: CCO[Si](OCC)(OCC)C1CC2C=CC1C2] | SIB0992.0 (5-BICYCLO[2.2.1]HEPT-2-ENYL)TRIETHOXYSILANE NORBORNENYLTRIETHOXYSILANE C₁₃H₂₄O₃Si 256.42 106-8°/8 0.960 1.4486 Coupling agent for norbornadiene rubbers Component in low dielectric constant films Undergoes ring-opening metathetic polymerization (ROMP) with | | | |
|---|---|---|---|---|
| | RuCl₂(P(C₆H₅)₃)₃.¹ | | | |
| | 1. Finkelstein, E. 10th Int'l Organosilicon Symp. Proc. 1993, P-120 | | | |
| | [18401-43-9] | TSCA EC-242- | 10 g | 50 g |
| | | 278-8 HMIS: 2- | | |

2-1-X

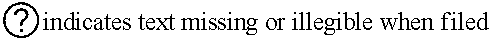

In accordance with an aspect, there is provided a rubber composition comprising the antioxidant described herein.

In an aspect, the rubber composition is vulcanized.

In an aspect, the rubber composition further comprises the catalyst described herein.

In accordance with an aspect, there is provided a tire comprising the rubber composition described herein.

The novel features of the present invention will become apparent to those of skill in the art upon examination of the following detailed description of the invention. It should be understood, however, that the detailed description of the invention and the specific examples presented, while indicating certain aspects of the present invention, are provided for illustration purposes only because various changes and modifications within the spirit and scope of the invention will become apparent to those of skill in the art from the detailed description of the invention and claims that follow.

### BRIEF DESCRIPTION OF THE DRAWINGS

The present invention will be further understood from the following description with reference to the Figures, in which:

FIG. 1 shows the results of tests according to ASTM D 2084 on natural rubber vulcanized in the present of sulfur, sulfur and zeolite, or sulfur and silica.

FIG. 2 shows the results of tests according to ASTM D 412 on natural rubber vulcanized in the present of sulfur, sulfur and zeolite, or sulfur and silica.

FIG. 3 shows the results of tests according to ASTM D 2084 on FKM rubber vulcanized in the present or absence of two different forms of zeolite and silica.

FIG. 4 shows the results of tests according to ASTM D 412 on FKM rubber vulcanized in the present or absence of two different forms of zeolite and silica.

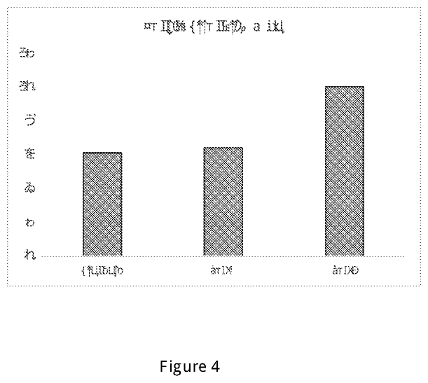

FIG. 5A shows the T90 of the natural rubber compounds. FIG. 5B shows the reduction in vulcanization time.

FIG. 6 shows the rheometric curve of the M1, M6 and m12 composites.

FIG. 7 shows the hardness of the compounds M1-M13.

FIG. 8 shows the tensile strength at rupture of the rubber compounds.

FIG. 9 shows the elongation at rupture of rubber compounds.

FIG. 10 shows the variation of abrasion (ARI-%) in rubber compounds. M1 is the reference. When ARI>100%, the rubber compound wore more than the reference. When ARI<100%, the rubber compound wore less than the reference.

### DETAILED DESCRIPTION OF CERTAIN ASPECTS

Described herein are catalysts and antioxidants, as well as rubber compositions and vulcanization methods and related uses.

### Definitions

The following definitions are used herein and should be referred to for interpretation of the claims and the specification:

The terms “elastomeric polymer,” “elastomer,” and “rubber” are used interchangeably herein to describe elastomeric polymers that typically contain double bond-containing rubbers designated as R rubbers according to DIN/ISO 1629. These rubbers have a double bond in the main chain and might contain double bonds in the side chain in addition to the unsaturated main chain. Elastomeric polymers should also be understood to include rubbers comprising a saturated main chain, which are designated as M rubbers according to ISO 1629 and might contain double bonds in the side chain in addition to the saturated main chain.

They include, for example: natural rubber (NR), polyisoprene rubber (IR), styrene-butadiene rubber (SBR), polybutadiene rubber (BR), nitrile rubber (NBR), butyl rubber (IIR), brominated isobutylene-isoprene copolymers with bromine contents of 0.1 to 10 wt. % (BIIR), chlorinated isobutylene-isoprene copolymers with chlorine contents of 0.1 to 10 wt. % (CIIR), hydrogenated or partially hydrogenated nitrile rubber (NBR, HNBR, HSN), styrene-butadiene-acrylonitrile rubber (SNBR), styrene-isoprene-butadiene rubber (SIBR), polychloroprene (neoprene) (CR), chlorosulfonated polyethylene (CSM), epichiorohydrin rubber (ECH, ECO), ethylene propylene diene monomer (EPDM), ethylene propylene rubber (EPR), fluoroelastomer (FKM), perfluoroelastomer (FFKM), polyacrylate rubber (ACM), polysulfide rubber (PSR), sanifluor, silicone rubber (SiR), chlorinated polyethylene (CM), or a combination comprising at least one of the foregoing.

The elastomeric polymer can be modified by further functional groups, such as hydroxyl, carboxyl, anhydride, amino, amido and/or epoxy functional groups are more typical. Functional groups can be introduced directly during polymerization by means of copolymerization with suitable co-monomers or after polymerization by means of polymer modification.

The term “catalyst” refers to any component, organic or inorganic, that speeds up a reaction, such as a vulcanization or crosslinking reaction. Typically, the catalyst described herein is a nanostructured porous catalyst and is typically a zeolite and/or a mesoporous compound.

The term “nanostructured” refers to a moiety that has an average diameter in the nanometer range, such as from about 1 to about 1000 nm.

The term “silicate” refers to any composition including silicate (or silicon oxide) within its framework. It is a general term encompassing, for example, pure-silica (i.e., absent other detectable metal oxides within the silicate framework), aluminosilicate, borosilicate, ferrosilicate, stannosilicate, titanosilicate, or zincosilicate structures.

The term “zeolite” refers to natural, synthetic, or hybrid crystalline alumina-silicate porous materials having a three-dimensional porous structure. Zeolites may include, for example, ZSM-5, A, X, Y, high silica zeolite, sodalite, modernite, clinoptilolite, faujasite, bentonite, erionite, or combinations thereof. The zeolite may be present in any amount but is typically in an amount of from about 0.1 to about 200 phr, such as from about 0.1, 0.5, 1, 5, 10, 15, 25, 50, 75, 100, 125, 150, or 175 to about 0.5, 1, 5, 10, 15, 25, 50, 75, 100, 125, 150, 175, or 200 phr.

Due to the presence of alumina, zeolites exhibit a negatively charged framework, which is counter-balanced by positive cations. These cations can be exchanged affecting pore size and adsorption characteristics. Examples are the potassium, sodium and calcium forms of zeolite A types having pore openings of approximately 3, 4 and 5 Angstrom respectively. Consequently they are called Zeolite 3A, 4A and 5A. The metal cation might also be ion exchanged with protons. Zeolites are typically microporous, with a pore size less than about 2 nm and typically in the A range.

The term “mesoporous” is a material containing pores with diameters between about 1 and about 50 nm. The mesoporous structure is typically based on at least one compound of at least one of the elements Si, W, Sb, Ti, Zr, Ta, V, B, Pb, Mg, Al, Mn, Co, Ni, Sn, Zn, In, Fe and Mo, if possible in a covalent bond with elements such as O, S, N, C. Typical mesoporous materials include some kinds of silica and alumina that have similarly-sized fine mesopores. Mesoporous oxides of niobium, tantalum, titanium, zirconium, cerium and tin have also been reported. Examples of mesoporous materials include SBA-15, MCM-48, SBA-1, SBA-6, SBA-16, FDU-2, and KIT-S, and MCM-41.

The term “crosslinking agent” refers to a compound that forms bridges or crosslinks between polymer chains. Crosslinking agents useful in vulcanizing rubber include, for example, sulfur, sulfur compounds e.g. 4,4′-dithiomorpholine; organic peroxides e.g. dicumyl peroxide; nitroso compounds e.g. p-dinitrosobenzene, bisazides and polyhydrosilanes, metal oxides, and bisphenols, such as bisphenol A. These can be used in any suitable amount and it will be understood that when different crosslinking agents, different amounts may be appropriate. For example, when sulfur is used, it may range from about 0.1 to about 40 wt %. Dicumyl peroxide may range from about 0.1 to about 16 wt %. For polychloroprene rubber, magnesium oxide is a typical crosslinking agent that is used in an amount of from about 0.1 to about 10 wt %.

The term “thermally conductive” refers to elements or compounds that can transfer heat. Examples of thermally conductive materials include, for example, a member selected from the group consisting of:

Aluminum, Antimony, Beryllium, Bismuth, Cadmium, Calcium, Chromium, Cobalt, Copper, Gold, Iron (α, β, γ, δ), Lead, Magnesium, Manganese (α, β, γ), Mercury (liquid), Molybdenum, Nickel (α, β), Palladium, Platinum, Potassium, Rhodium, Silicon, Silver, Sodium, Thorium, Titanium, Tungsten, Vanadium, Zinc, Al₂O₃, B₂O₃, CaO, Cr₂O₃, CuO, Fe₂O₃, Fe₃O₄, PbO, PbO₂, MgO, NiO, SiO₂ quartz α, SiO₂ quartz β, SiO₂ cristobalite α, SiO₂ cristobalite R, TiO, U₃O₈, ZnO, ZrO₂, AlF₃, CaF₂, KF, NaF, and/or a member of the following table:

| | Condutividade | | Condutividade |
|---|---|---|---|
| Material | térmica (W/mK) | Material | térmica (W/mK) |
| Carbono (nanotubos) | 6000 | Silica (SiO2) | 1.38 |
| Grafite pirolitico | 1500 | Vidro comum | 1.00 |
| (HOPG) | | | |
| Diamante | 1000 | Concreto | 0.800 |
| Praia (Ag) | 426 | Agua | 0.610 |
| Cobre (Cu) | 380 | Polietileno alta | 0.500 |
| | | densidade | |
| Ouro (Au) | 318 | Papel | 0.330 |
| Aluminio (Al) | 230 | Glicerina | 0.284 |
| Carbeto de silicia | 200 | Polipropileno | 0.250 |
| (SiC) | | | |
| Tungstenio (W) | 178 | Teflon | 0.250 |
| Silicio (Si) | 148 | Etilenoglicol | 0.240 |
| Zinco (Zn) | 112 | PVC | 0.200 |
| Latao (70Cu-30Zn) | 109 | PET (Mylar) | 0.176 |
| Niquel (Ni) | 88.00 | Epoxi | 0.160 |
| Ferro (Fe) | 80.30 | Oelo de carnauba | 0.160 |
| Bronze (90Cu, 10Al) | 52.00 | Baquelite | 0.150 |
| Solda estanho/ | 50.21 | Oleo mineral para | 0.144 |
| chumbo (60Sn/40Pb) | | transformadores | |
| Aça | 50.20 | Oleo Lubrax | 0.135 |
| Safira (SiO2) | 41.00 | Maderia (compensado) | 0.120 |
| Chumbo (Pb) | 24.70 | Poliamida (Kapton) | 0.120 |
| Alumina (Ceramica - | 30.00 | Vermiculita | 0.050 |
| Al2O3) | | | |
| Titanio (Ti) | 21.00 | La de vidro ou de | 0.045 |
| | | rocha | |
| Mercurio (Hg) | 8.30 | Feltro | 0.040 |
| Basalto | 3.50 | Poliestireno | 0.040 |
| | | expandid (isopar) | |
| Arenito (Pedra gres) | 1.60 | Cortica | 0.039 |
| Geio | 1.60 | Ar | 0.026 |
| Virdo borossilcato | 1.40 | Poliuretano (espuma) | 0.024 |

The term “organosilane” is used herein to define any organic derivative of a silane containing at least one carbon to silicon bond. The organosilane, when present, is typically used in an amount of from about 0.01% to about 10% w/w, such as from about 0.01%, about 0.05%, about 0.1%, about 0.15%, about 0.2%, about 0.25%, about 0.5%, about 0.75%, about 1%, about 1.5%, about 2%, or about 5% to a bout 0.05%, about 0.1%, about 0.15%, about 0.2%, a bout 0.25%, about 0.5%, about 0.75%, 1%, about 1.5%, about 2%, about 5%, or about 10% w/w. Typically, the organosilane is used in an amount of about 1% w/w.

The term “lignin” class of complex organic polymers that form important structural materials in the support tissues of vascular plants and some algae. Lignins are particularly important in the formation of cell walls, especially in wood and bark, because they lend rigidity and do not rot easily. Chemically, lignins are cross-linked phenolic polymers. Lignin is generally considered to be industrial waste product of the paper and pulp industries.

The term “organosilane” refers to organometallic compounds containing carbon-silicon bonds. Examples include at least:

XIAMETER® OFS-6070 Silane Methyl Methoxy Methyltrimethoxysilane

Dow Corning® 1-6383 Silane Methyl Ethoxy Methyltriethoxysilane

XIAMETER® OFS-6194 Silane Methyl Methoxy Dimethyldimethoxysilane

Dow Corning® Z-6265 Silane Propyl Methoxy Propyltrimethoxysilane

XIAMETER® OFS-2306 Silane i-Butyl Methoxy Isobutyltrimethoxysilane

XIAMETER® OFS-6124 Silane Phenyl Methoxy Phenyltrimethoxysilane

XIAMETER® OFS-6341 Silane n-Octyl Ethoxy n-Octyltriethoxysilane

Dow Corning® Z-6011 Silane Amino Ethoxy Aminopropyltriethoxysilane

XIAMETER® OFS-6020 Silane Amino Methoxy Aminoethylaminopropyltrimethoxysilane XIAMETER® OFS-6094 Silane Amino Methoxy Aminoethylaminopropyltrimethoxysilane (high purity)

Dow Corning® Z-6137 Silane Amino-Aminoethylaminopropylsiloxane oligomers (aq) XIAMETER® OFS-6032 Silane Vinyl-benzyl-amino Methoxy Vinylbenzylated aminoethylaminopropyltrimethoxysilane

XIAMETER® OFS-6224 Silane Vinyl-benzyl-amino Methoxy Low CI version of XIAMETER® OFS-6032 Silane

Dow Corning® Z-6028 Silane Benzylamino Methoxy Benzylated-aminoethylaminopropyltrimethoxysilane

XIAMETER® OFS-6030 Silane Methacrylate Methoxy g-Methacryloxypropyltrimethoxysilane XIAMETER® OFS-6040 Silane Epoxy Methoxy g-Glycidoxypropyltrimethoxysilane

XIAMETER® OFS-6076 Silane Chloropropyl Methoxy g-Chloropropyltrimethoxysilane

Dow Corning® Z-6376 Silane Chloropropyl Ethoxy g-Chloropropyltriethoxysilane

Dow Corning® Z-6300 Silane Vinyl Methoxy Vinyltrimethoxysilane

XIAMETER® OFS-6075 Silane Vinyl Acetoxy Vinyltriacetoxysilane

Dow Corning® Z-6910 Silane Mercapto Ethoxy Mercaptopropyltriethoxysilane

XIAMETER® OFS-6920 Silane Disulfido Ethoxy Bis-(triethoxysilylpropyl)-disulfide

XIAMETER® OFS-6940 Silane Tetrasulfido Ethoxy Bis-(triethoxysilylpropyl)-tetrasulfide

Dow Corning® Z-6675 Silane Ureido Methoxy g-Ureidopropyltriethoxysilane

XIAMETER® OFS-6106 Silane Epoxy/melamine Methoxy Epoxy silane modified melamine resin

Bis[3-(triethoxysilyl)propyl]polysulfide (Si69®)

| 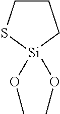 | Sulfur Functional Silanes - Trialkoxy SID3454.0 2,2-DIMETHOXY-1-THIA-2-SILACYCLOPENTANE C₅H₁₂O₂SSi 164.29 57-8°/7 1.094 Reagent for modification of silver and gold surfaces Coupling agent for rubber [26903-85-5] HMIS: 3-3-1-X 25 g | | | | |
|---|---|---|---|---|---|
| 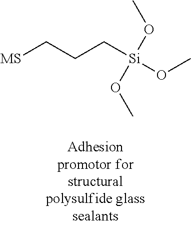 | SIM6476.0 3-MERCAPTOPROPYLTRIMETHOXYSILANE C₆H₁₆O₃SSi 196.34 93°/40 1.051²⁵ 1.4502²⁵ Viscosity: 2 cST Flashpoint: 96° C. (205° F.) yc of treated surfaces: 41 mN/m TOXICITY: oral rat, LD50: 2,380 mgkg Specific wetting surface: 348 m²/g Primary irritation index: 0.19 Coupling agent for EPDM and mechanical rubber applications Adhesion promoter for polysulfide adhesives For enzyme immobilization.¹ Treatment of mesoporous silica yields highly efficient heavy metal scavenger.² Couples fluorescent biological tags to semiconductor CdS nanoparticles.³ Modified mesoporous silica supports Pd in coupling reactions.⁴ Used to make thiol-organosilica nanoparticles.⁵ Forms modified glass and silica surfaces suitable for SILAR fabrication of CdS | | | | |
| | thin films.⁸ | | | | |
| | 1. Stjernlof, P. et al. Tetrahedron Lett. 1990, 31, 5773. | | | | |
| | 2. Liu, J. et al. Science 1997, 276, 923. | | | | |
| | 3. Bruchez, M. et al. Science 1998, 281, 2013. | | | | |
| | 4. Crudden, C. et al. J. Am. Chem. Soc. 2005, 127, 10045. | | | | |
| | 5. Nakamura, M; Ishimura, K. Langmuir 2008, 24, 5099. | | | | |
| | 6. Sun, H. et al. Dispersion Sci. Technol. 2005, 26, 719. | | | | |
| | [4420-74-0] | TSCA EC 224-588- | 100 g | 2 kg | 18 kg |

5 HMIS: 3-2-1-X

| | |
|---|---|
| 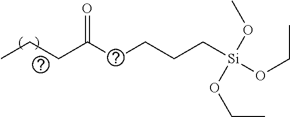 | SIO6704.0 S-(OCTANOYL)MERCAPTOPROPYLTRIETHOXYSILANE C₁₇H₃₆O₄SSi 364.62 0.9686 1.4515 Flashpoint: 176° C. (349° F.) TOXICITY: oral rat, LD50: >2,000 mg/kg Masked mercaptan - deblocked with alcohols Latent coupling agent for butadiene rubber [220727-26-4] TSCA HMIS: 2-1-1-X 25 g 100 g 18 kg |
| 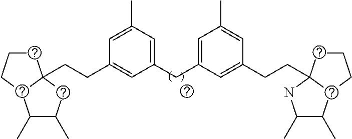 | Sulfur Functional Silanes - Dipodal SIB1820.5 BIS[m-(2-TRIETHOXYSILYLETHYL)TOLYL]POLYSULFIDE, tech-90 C₃₀H₅₀O₆S(₂₋₄)Si₂ 627-691 1.10 1.533 Dark, viscous liquid Flashpoint: 55° C. (131° F.) Coupling agent for SBR rubber [198087-81-9]/[85912- TSCA HMIS: 2- 25 g 2 kg 75-0]/[67873-85-2] 2-1-X |
| 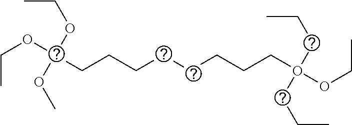 | SIB1824.6 BIS[3-(2-TRIETHOXYSILYL)PROPYL]DISULFIDE, 90% BIS(TRI- ETHOXYSILYL)-4,5-DITHIOOCTANE C₁₈H₄₂O₆S₂Si₂ 474.82 1.025 1.457 Contains sulfide and tetrasulfide Flashpoint: 75° C. (167° C.) Dipodal coupling agent/vulcanizing agent for rubbers Intermediate for mesoporous silicas with acidic pores.¹ 1. Alauzan, J. et al. J. Am. Chem. Soc. 2006, 128, 8718. [56706-10-6] TSA EC 260- 25 g 100 g 2 kg |
| | 350-7-HIS: 2- |
| | 2-1-X |
| 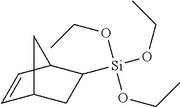 [SMILES: CCO[Si](OCC)(OCC)C1CC2C=CC1C2] | SIB0992.0 (5-BICYCLO[2.2.1]HEPT-2-ENYL)TRIETHOXYSILANE NORBORNENYLTRIETHOXYSILANE C₁₃H₂₄O₃Si 256.42 106-8°/8 0.960 1.4486 Coupling agent for norbornadiene rubbers Component in low dielectric constant films Undergoes ring-opening metathetic polymerization (ROMP) with |
| | RuCl₂(P(C₈H₅)₃)₃.¹ |
| | 1. Finkelstein, E. 10th Int'l Organosilicon Symp. Proc. 1993, P-120 |
| | [18401-43-9] TSCA EC 242- 10 g 50 g |
| | 278-8 HMIS: 2- |
| | 2-1-X |

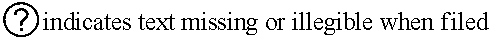

In aspects, the organosilanes may comprise functional groups to improve compatibility with rubber, such as those listed below.

| | Resin | | | | | | | |
|---|---|---|---|---|---|---|---|---|
| Functional | Thermoplastic resins | | | | | | | |
| Groups | Polyethylene | Polypropylene | Polystyrene | Acrylic | PVC | Polycarbonate | Nylon | Urethane |
| Vinyl | ++ | ++ | | | | | | |
| Epoxy | + | + | + | + | + | + | + | + |
| Styryl | | | + | + | | | | |
| Methacryloxy | ++ | ++ | ++ | + | | + | | + |
| Acryloxy | + | + | + | + | | + | | + |
| Amino | + | + | ++ | ++ | ++ | + | ++ | + |
| Ureide | | | | | | | ++ | |
| Mercapto | + | + | + | | | | | + |
| Isocyanate | | | | | | + | + | ++ |

| | Resin | | | | | | | |
|---|---|---|---|---|---|---|---|---|
| | | | Thermosetting resins | | | | | |
| Functional | Thermoplastic resins | | | | | | | Diallyl |
| Groups | PBT-PET | ABS | Melamine | Phenolic | Epoxy | Urethane | Polyimide | phthalate |
| Vinyl | | | | | | | | + |
| Epoxy | + | + | + | + | + | + | + | + |
| Styryl | | | | | | | | |
| Methacryloxy | | ++ | | | | | | + |
| Acryloxy | | ++ | | | | | | + |
| Amino | + | + | + | ++ | ++ | + | + | |
| Ureide | | | | + | | + | + | |
| Mercapto | | + | | + | + | + | | |
| Isocyanate | + | + | + | + | + | ++ | + | |

| | Resin | | | | | | |
|---|---|---|---|---|---|---|---|
| | Thermosetting resins | | Elastomer-Rubber | | | | |
| | Unsatu- | | Polybu- | Polyiso- | Sulfur- | Peroxide | |
| Functional | rated | | tadiene | prene | crosslinked | Crosslinked | |
| Groups | polyester | Furan | rubber | rubber | EPDM | EPDM | SBR |
| Vinyl | + | | | | + | + | |
| Epoxy | + | + | | | | | + |
| Styryl | | | | | | | |
| Methacryloxy | ++ | | | | + | ++ | |
| Acryloxy | ++ | | | | + | ++ | |
| Amino | | ++ | | | + | + | |
| Ureide | | | | | | | |
| Mercapto | | | + | + | ++ | + | + |
| Isocyanate | | + | | | | | |

| | Resin | | | | | |
|---|---|---|---|---|---|---|
| | Elastomer-Rubber | | | | | |
| | | Epichlo- | | | | |
| Functional | Nitrile | rohydrin | Neoprene | Butyl | | Urethane |
| Groups | rubber | rubber | rubber | rubber | Polysulfide | rubber |
| Vinyl | | | | | | |
| Epoxy | + | + | | + | + | + |
| Styryl | | | | | | |
| Methacryloxy | | | | | | |
| Acryloxy | | | | | | |
| Amino | + | | + | + | + | + |
| Ureide | | | | | | |
| Mercapto | + | + | + | | + | ++ |
| Isocyanate | | | | | | + |

++: Very effective
+: Effective
*Not all the functional groups are capable of coupling with the resins in question. This should be taken as a guide.

The term “surfactant” is short for surface active agent. Surfactants are amphiphilic compounds, meaning they contain two or more groups that, in their pure form, are insoluble in each other. Surfactants typically have at least one hydrophobic tail and at least one hydrophilic head and, more typically, surfactants have a single hydrophobic tail and a single hydrophilic head. Surfactants typically act to lower surface tension and can provide wetting, emulsification, foam, and detergency. It will be understood that any surfactant or combination of surfactants can be used in the rubber compositions described here, provided that the surfactant(s) can suitably be combined with the other listed components to produce a rubber. Thus, the surfactants described herein can be zwitterionic, amphiphilic, cationic, anionic, non-ionic, or combinations thereof and can include two or more surfactants from one such group or from different groups. One or more surfactants can be included in the compositions and methods described herein. Non-exhaustive examples of surfactants include cetyltrimethylammonium bromide (CTAB) and those listed in the below table:

In understanding the scope of the present application, the articles “a”, “an”, “the”, and “said” are intended to mean that there are one or more of the elements. Additionally, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

It will be understood that any aspects described as “comprising” certain components may also “consist of” or “consist essentially of,” wherein “consisting of” has a closed-ended or restrictive meaning and “consisting essentially of” means including the components specified but excluding other components except for materials present as impurities, unavoidable materials present as a result of processes used to provide the components, and components added for a purpose other than achieving the technical effect of the invention. For example, a composition defined using the phrase “consisting essentially of” encompasses any known acceptable additive, excipient, diluent, carrier, and the like. Typically, a composition consisting essentially of a set of components will comprise less than 5% by weight, typically less than 3% by weight, more typically less than 1%, and even more typically less than 0.1% by weight of non-specified component(s).

It will be understood that any component defined herein as being included may be explicitly excluded from the claimed invention by way of proviso or negative limitation.

In addition, all ranges given herein include the end of the ranges and also any intermediate range points, whether explicitly stated or not.

Finally, terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

### Catalysts

Described herein are nanostructured porous catalysts for rubber vulcanization. The catalysts generally comprise a high surface area and are typically zeolites and/or mesoporous compounds. The zeolite is typically selected from the group consisting of ZSM-5, A, X, Y, high silica zeolite, sodalite, modernite, clinoptilolite, faujasite, bentonite, erionite, and combinations thereof and the mesoporous compound is typically selected from the group consisting of SBA-15, MCM-48, SBA-1, SBA-6, SBA-16, FDU-2, KIT-S, MCM-41 and combinations thereof.

The zeolite might be added to the composition in form of fine powders or as an aggregated dispersible particles. To achieve the good dispersion of the activated zeolite, the zeolite is preferably in the form of fine, small, dispersible particles that might be aggregated into larger agglomerates or processed into pellets. Generally the dispersed average particle size is in the range of 0.1-200 μm and more preferably the zeolite has an average particle size of 0.2-50 μm. This results in a large number of well dispersed sites within the vulcanizable rubber composition providing the highest effect in increasing cure rate of the vulcanizable rubber composition and will not negatively affect surface quality of the shaped and vulcanized article.

The amount of activated zeolite used in the process depends on the required cure rate increasing effect, but also on the type of zeolite used, its pore size and level of deactivation. Preferably the level of activated zeolite is from 0.1 to 20 phr (parts per hundred parts rubber), more preferably from 0.5 to 15 phr and most preferred from 1 to 10 phr. If more than one activated zeolite is employed, the amount of activated zeolite mentioned before relates to the sum of the activated zeolites employed.

Advantageously, another component may be adsorbed onto the catalyst or otherwise supported on the catalyst. For example, a crosslinking agent and/or an activator can be supported by the catalyst. In aspects, the crosslinking agent is selected from the group consisting of sulfur, sulfur compounds e.g. 4,4′-dithiomorpholine; organic peroxides e.g. dicumyl peroxide; nitroso compounds e.g. p-dinitrosobenzene, bisazides, polyhydrosilanes, metal oxides bisphenols, such as bisphenol A, and combinations thereof. Typically, the crosslinking agent is sulfur, such as rhombic sulfur and assists in positioning the crosslinking agent near a carbon atom in the rubber.

Typically, the activator is thermally conductive and, in this way, reduces vulcanization time. The activator is typically selected from the group consisting of:

Aluminum, Antimony, Beryllium, Bismuth, Cadmium, Calcium, Chromium, Cobalt, Copper, Gold, Iron (α, β, γ, δ), Lead, Magnesium, Manganese (α, β, γ), Mercury (liquid), Molybdenum, Nickel (α, β), Palladium, Platinum, Potassium, Rhodium, Silicon, Silver, Sodium, Thorium, Titanium, Tungsten, Vanadium, Zinc, Al₂O₃, B₂O₃, CaO, Cr₂O₃, CuO, Fe₂O₃, Fe₃O₄, PbO, PbO₂, MgO, NiO, SiO₂ quartz α, SiO₂ quartz β, SiO₂ cristobalite α, SiO₂ cristobalite β, TiO, U₃O₈, ZnO, ZrO₂, AlF₃, CaF₂, KF, NaF, and/or a member of the following table:

| | Condutividade |
|---|---|
| Material | térmica (W/mK) |
| Carbono (nanotubos) | 6000 |
| Grafite pirolitico (HOPG) | 1500 |
| Diamante | 1000 |
| Prata (Ag) | 426 |
| Cobre (Cu) | 380 |
| Ouro (Au) | 318 |
| Aluminio (Al) | 230 |
| Carbeto de silicia (SiC) | 200 |
| Tungstenio (W) | 178 |
| Silicio (Si) | 148 |
| Zinco (Zn) | 112 |
| Latao (70Cu—30Zn) | 109 |
| Niquel (Ni) | 88.00 |
| Ferro (Fe) | 80.30 |
| Bronze (90Cu, 10Al) | 52.00 |
| Solda estanho/chumbo | 50.21 |
| (60Sn/40Pb) | |
| Aça | 50.20 |
| Safira (SiO2) | 41.00 |
| Chumbo (Pb) | 24.70 |
| Alumina (Ceramica - | 30.00 |
| Al2O3) | |
| Titanio (Ti) | 21.00 |
| Mercurio (Hg) | 8.30 |
| Basalto | 3.50 |
| Arenito (Pedra gres) | 1.60 |
| Geio | 1.60 |
| Virdo borossilcato | 1.40 |
| Silica (SiO2) | 1.38 |
| Vidro comum | 1.00 |
| Concreto | 0.800 |
| Agua | 0.610 |
| Polietileno alta densidade | 0.500 |
| Papel | 0.330 |
| Glicerina | 0.284 |
| Polipropileno | 0.250 |
| Teflon | 0.250 |
| Etilenoglicol | 0.240 |
| PVC | 0.200 |
| PET (Mylar) | 0.176 |
| Epoxi | 0.160 |
| Oelo de carnauba | 0.160 |
| Baquelite | 0.150 |
| Oleo mineral para | 0.144 |
| transformadores | |
| Oleo Lubrax | 0.135 |
| Maderia (compensado) | 0.120 |
| Poliamida (Kapton) | 0.120 |
| Vermiculita | 0.050 |
| La de vidro ou de rocha | 0.045 |
| Feltro | 0.040 |
| Poliestireno expandid | 0.040 |
| (isopar) | |
| Cortica | 0.039 |
| Ar | 0.026 |
| Poliuretano (espuma) | 0.024 |

It is also contemplated that the catalyst is free of an adsorbed component.

The rubber to be vulcanized may be any elastomeric polymer and is typically selected from the group consisting of natural rubber (NR), polyisoprene rubber (IR), styrene-butadiene rubber (SBR), polybutadiene rubber (BR), nitrile rubber (NBR), butyl rubber (IIR), brominated isobutylene-isoprene copolymers with bromine contents of 0.1 to 10 wt. % (BIIR), chlorinated isobutylene-isoprene copolymers with chlorine contents of 0.1 to 10 wt. % (CIIR), hydrogenated or partially hydrogenated nitrile rubber (NBR, HNBR, HSN), styrene-butadiene-acrylonitrile rubber (SNBR), styrene-isoprene-butadiene rubber (SIBR), polychloroprene (neoprene) (CR), chlorosulfonated polyethylene (CSM), epichiorohydrin rubber (ECH, ECO), ethylene propylene diene monomer (EPDM), ethylene propylene rubber (EPR), fluoroelastomer (FKM), perfluoroelastomer (FFKM), polyacrylate rubber (ACM), polysulfide rubber (PSR), sanifluor, silicone rubber (SiR), chlorinated polyethylene (CM), and combinations thereof.

The catalysts described herein may be used in any suitable amount. In aspects, the catalysts are used in amount of from about 0.5 to about 15 wt % of the rubber composition, such as from about 1 to about 10 wt %, such as from about 1, 2, 3, 4, 5, 6, 7, 8, or 9 wt % to about 2, 3, 4, 5 6, 7, 8, 9, or 10 wt %. Typically, the catalyst is used in an amount of from about 2 to about 5 wt %, such as about 2, 3, 4, or 5 wt %.

Also provided herein are rubber compositions, before and after vulcanization, as well as finished product such as tires, comprising at least one catalyst described herein. It is contemplated that multiple such catalysts may be used together in order to further improve vulcanization time and/or rheological properties of the final rubber product. In aspects, the two or more combined catalysts may act additively or synergistically to improve vulcanization time and/or rubber quality/properties.

The rubber compositions described herein may further comprise lignin, as will be explained below. The lignin may be modified to improve its compatibility with the rubber compositions and, in particular, the lignin may be organosilane-modified.

### Organosilanes

Also described herein is an organosilane for rubber vulcanization. The organosilane includes organosilanes per se and organosilane-modified compounds, such as an organosilane-modified lignin or organosilane-modified zeolite. The organosilane modification is chosen so as to improve the compatibility of the compound, such as lignin or zeolite, with the rubber composition. For example, in aspects, the organosilane or organosilane modification is selected from the group consisting of:

### XIAMETER® OFS-6070 Silane Methyl Methoxy Methyltrimethoxysilane

### Dow Corning® 1-6383 Silane Methyl Ethoxy Methyltriethoxysilane

### XIAMETER® OFS-6194 Silane Methyl Methoxy Dimethyldimethoxysilane

### Dow Corning® Z-6265 Silane Propyl Methoxy Propyltrimethoxysilane

XIAMETER® OFS-2306 Silane i-Butyl Methoxy Isobutyltrimethoxysilane

### XIAMETER® OFS-6124 Silane Phenyl Methoxy Phenyltrimethoxysilane

XIAMETER® OFS-6341 Silane n-Octyl Ethoxy n-Octyltriethoxysilane

### Dow Corning® Z-6011 Silane Amino Ethoxy Aminopropyltriethoxysilane

### XIAMETER® OFS-6020 Silane Amino Methoxy Aminoethylaminopropyltrimethoxysilane

XIAMETER® OFS-6094 Silane Amino Methoxy Aminoethylaminopropyltrimethoxysilane (high purity)
Dow Corning® Z-6137 Silane Amino-Aminoethylaminopropylsiloxane oligomers (aq)
XIAMETER® OFS-6032 Silane Vinyl-benzyl-amino Methoxy Vinylbenzylated aminoethylaminopropyltrimethoxysilane
XIAMETER® OFS-6224 Silane Vinyl-benzyl-amino Methoxy Low CI version of XIAMETER® OFS-6032 Silane
Dow Corning® Z-6028 Silane Benzylamino Methoxy Benzylated aminoethylaminopropyltrimethoxysilane
XIAMETER® OFS-6030 Silane Methacrylate Methoxy g-Methacryloxypropyltrimethoxysilane
XIAMETER® OFS-6040 Silane Epoxy Methoxy g-Glycidoxypropyltrimethoxysilane
XIAMETER® OFS-6076 Silane Chloropropyl Methoxy g-Chloropropyltrimethoxysilane
Dow Corning® Z-6376 Silane Chloropropyl Ethoxy g-Chloropropyltriethoxysilane

### Dow Corning® Z-6300 Silane Vinyl Methoxy Vinyltrimethoxysilane

### XIAMETER® OFS-6075 Silane Vinyl Acetoxy Vinyltriacetoxysilane

### Dow Corning® Z-6910 Silane Mercapto Ethoxy Mercaptopropyltriethoxysilane

XIAMETER® OFS-6920 Silane Disulfido Ethoxy Bis-(triethoxysilylpropyl)-disulfide
XIAMETER® OFS-6940 Silane Tetrasulfido Ethoxy Bis-(triethoxysilylpropyl)-tetrasulfide
Dow Corning® Z-6675 Silane Ureido Methoxy g-Ureidopropyltriethoxysilane
XIAMETER® OFS-6106 Silane Epoxy/melamine Methoxy Epoxy silane modified melamine resin

### Bis[3-(triethoxysilyl)propyl]polysulfide (Si69®)

| 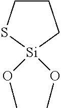 | Sulfur Functional Silanes - Trialkoxy SID3454.0 2,2-DIMETHOXY-1-THIA-2-SILACYCLOPENTANE C₅H₁₂O₂SSi 164.29 57-8°/7 1.094 Reagent for modification of silver and gold surfaces Coupling agent for rubber [26903-85-5] HMIS: 3-3-1-X 25 g | | | | |
|---|---|---|---|---|---|
| 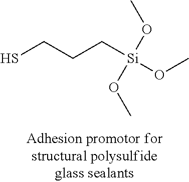 | SIM6476.0 3-MERCAPTOPROPYLTRIMETHOXYSILANE C₆H₁₆O₃SSi 196.34 93°/40 1.051²⁵ 1.4502²⁵ Viscosity: 2 cSt Flashpoint: 96° C. (205° F.) yc of treated surfaces: 41 mN/m TOXICITY: oral rat, LD50: 2,380 mg/kg Specific wetting surface: 348 m²/g Primary irritation index: 0.19 Coupling agent for EPDM and mechanical rubber applications Adhesion promoter for polysulfide adhesives For enzyme immobilization.¹ Treatment of mesoporous silica yields highly efficient heavy metal scavenger.² Couples fluorescent biological tags to semiconductor CdS nanoparticles.³ Modified mesoporous silica supports Pd in coupling reactions.⁴ | | | | |
| | Used to make thiol-organosilica nanoparticles.⁵ | | | | |
| | Forms modified glass and silica surfaces suitable for SILAR fabrication of CdS | | | | |
| | thin films.⁶ | | | | |
| | 1. Stjernlof, P. et al. Tetrahedron Lett. 1990, 31, 5773. | | | | |
| | 2. Liu, J. et al Science 1997, 276, 923. | | | | |
| | 3. Bruchez, M. et al. Science 1998, 281, 2013. | | | | |
| | 4. Crudden, C. et al. J. Am. Chem. Soc. 2005, 127, 10045. | | | | |
| | 5. Nakamura, M; Ishimura, K. Langmuir 2008, 24, 5099. | | | | |
| | 6. Sun, H. et al. Dispersion Sci. Technol. 2005, 26, 719. | | | | |
| | [4420-74-0] | TSCA EC 224-588- | 100 g | 2 kg | 18 kg |
| | | 5 HMIS; 3-2- | | | |
| | | 1-X | | | |

| 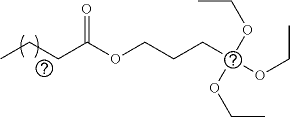 | SIO6704.0 S-(OCTANOYL)MERCAPTOPROPYLTRIETHOXYSILANE C₁₇H₃₆O₄SSi 364.62 0.9686 1.4515 Flashpoint: 176° C. (349° F.) TOXICITY: oral rat, LD50: >2,000 mg/kg Masked mercaptan - deblocked with alcohols Latent coupling agent for butadiene rubber [220727-26- TSCA HMIS: 2-1- 25 g 100 g 18 kg 4] 1-X | | | | |
|---|---|---|---|---|---|
| 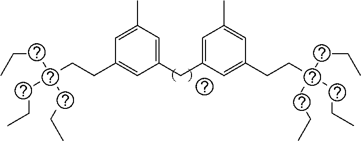 | Sulfur Functional Silanes - Dipodal SIB1820.5 BIS[m-(2-TRIETHOXYSILYLETHYL)TOLYL]POLYSULFIDE, tech-90 C₃₀H₅₀O₆S(₂₋₄)Si₂ 627-691 1.10 1.533 Dark, viscous liquid Flashpoint: 55° C. (131° F.) Coupling agent for SBR rubber [198087-81- TSCA HMIS: 25 g 2 kg 9]/[85912-75- 2-2-1-X 0]/[67873-85-2] | | | | |
| 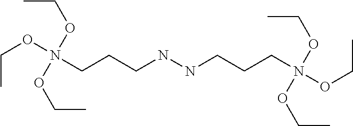 | SIB1824.6 BIS[3-(2-TRIETHOXYSILYL)PROPYL]DISULFIDE, 90% BIS(TRIETHOXYSILYL)-4,5-DITHIOOCTANE C₁₈H₄₂O₆S₂Si₂ 474.82 1.025 1.457 Contains sulfide and tetrasulfide Flashpoint: 75° C. (167° F.) Dipodal coupling agent/vulcanizing agent for rubbers Intermediate for mesoporous silicas with acidic pores.¹ 1. Alauzan, J. et al. J. Am. Chem. Soc. 2006, 128, 8718. | | | | |
| | [56706-10-6] | TSCA EC 260- | 25 g | 100 g | 2 kg |
| | | 350-7 HMIS:2- | | | |
| | | 2-1-X | | | |

| 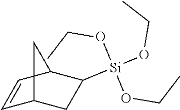 [SMILES: CCO[Si](OCC)(OCC)C1CC2C=CC1C2] | SIB0992.0 (5-BICYCLO[2.2.1]HEPT-2-ENYL)TRIETHOXYSILANE NORBORNENYLTRIETHOXYSILANE C₁₃H₂₄O₃Si 256.42 106-8°/8 0.960 1.4486 Coupling agent for norbornadiene rubbers Component in low dielectric constant films Undergoes ring-opening metathetic polymerization (ROMP) with | | | |
|---|---|---|---|---|
| | RuCl₂(P(C₆H₅)₃)₃.¹ | | | |
| | 1. Finkelstein, E. 10th Int'l Organosilicon Symp. Proc. 1993, P-120 | | | |
| | [18401-43-9] | TSCA EC-242- | 10 g | 50 g |
| | | 278-8 HMIS: 2- | | |
| | | 2-1-X | | |

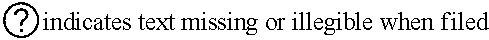

Thus, also provided herein are rubber compositions, vulcanized or not, that comprise one or more of the antioxidants described herein.

### Vulcanization Methods

Also provided herein are methods of vulcanizing rubber compositions. The vulcanization method is typically the conventional method used, with the catalyst(s) and/or organosilane(s) and/or organosilane-modified catalysts described herein being used in addition to or to replace one or more conventional catalysts and/or organosilanes. In aspects, this addition or substitution results in a vulcanized rubber product with advantageous properties and/or it yields vulcanized rubber product in a shorter time period than the conventional methods. For example, by using the components described herein in methods of vulcanizing rubber, there is typically an increase of the speed of vulcanization or, in other words, a reduction in ts2 and t90 times in relation to a material that does not contain the components described herein. This is because cross-linking is occurring more quickly. Further, there may be an improvement in the properties of rupture and elongation and a reduction in abrasion.

### Products

The catalysts, organosilanes, vulcanization methods, and rubber compositions described herein can be used for any known purpose, such as in tires, shoe soles, hoses, conveyor belts clarinet and saxophone mouth pieces, bowling balls, and hockey pucks.

The above disclosure generally describes the present invention. A more complete understanding can be obtained by reference to the following specific Examples. The Examples are described solely for purposes of illustration and are not intended to limit the scope of the invention. Changes in form and substitution of equivalents are contemplated as circumstances may suggest or render expedient. Although specific terms have been employed herein, such terms are intended in a descriptive sense and not for purposes of limitation.

### EXAMPLES

### Example 1: Preparation and Use of Zeo-S and Si—S as Cure Agents

50 grams of sulfur (powder) and 100 grams of zeolite (powder) were placed in a vessel, forming a solid heterogeneous mixture, both 325 mesh materials. The heterogeneous mixture was heated using for 6.5 hours at 140° C. The homogeneous liquid mixture was cooled to a solid, the solid was manually mass-sieved and screened through a 325 mesh. The same procedure was repeated using 50 grams of sulfur (powder) and 100 grams of precipitated silica (powder).

Three natural rubber formulations were prepared using conventional sulfur, Zeo-S, or Si—S as shown in Table 1 below:

TABLE 1
Comparative example showing formulations using S₈, Zeo-S, or Si-S.

| Material (PHR) | S₈ | Zeo-S | Si-S |
|---|---|---|---|
| Natural Rubber | 100.0 | 100.0 | 100.0 |
| (RSS1) | | | |
| Zinc Oxide | 6.0 | 6.0 | 6.0 |
| Stearic Acid | 0.5 | 0.5 | 0.5 |
| TBBS¹ | 0.7 | 0.7 | 0.7 |
| S₈ | 3.5² | | |
| Zeo-S | | 10.5 | |
| | | (3.5² Sulfur Content) | |
| Si-S | | | 10.5 |
| | | | (3.5² Sulfur Content) |
| TOTAL | 110.7 | 117.7 | 117.7 |

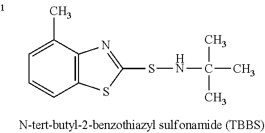 [SMILES: Cc1cccc2sc(SNC(C)(C)C)nc12]

²Sulfur (S₈) content equivalent of 3.5 PHR is 0.01365 mol of S₈ = 256.48 g/mol

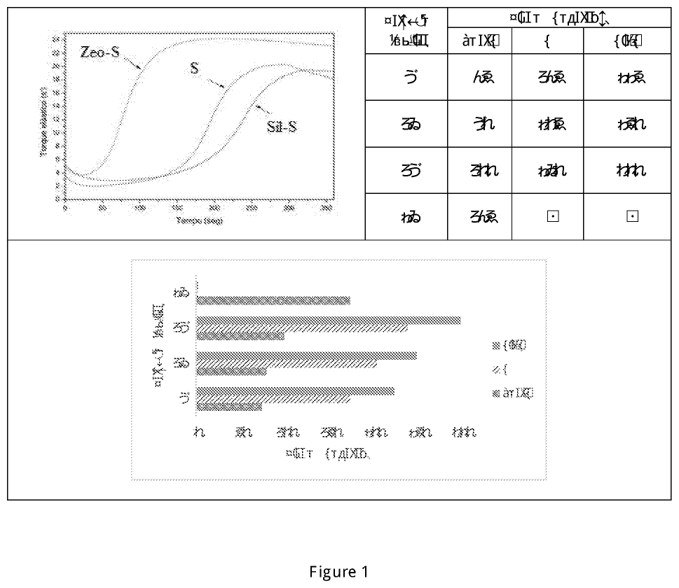

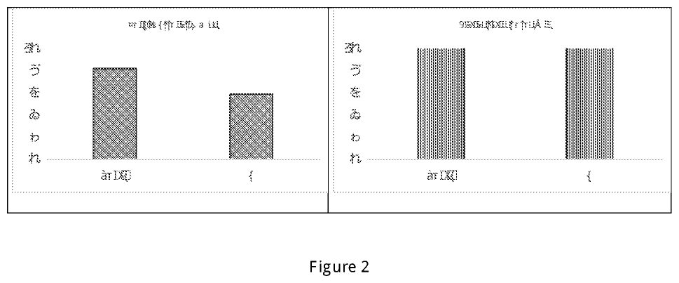

Rheological parameters were tested under ASTM D 2084 (170° C. —6 minutes) and results are shown in FIG. 1. Mechanical properties were tested under ASTM D 412 (rupture tension and elongation) and results are shown in FIG. 2. There was an increase observed in the torque, for example, to 18 lbf/in from 240 seconds to 100 seconds (reducing 60% of time) when used Zeo-S was used. In addition, the rupture tension was increased by 32% with Zeo-S and there were no significant alterations in elongation proprieties when Zeo-S was compared to conventional sulfur.

### Example 2: Testing an Elastomer that does not Use Sulfur for Crosslinking

Three different formulations of FKM rubber were prepared as shown in Table 2 below using a rubber mixing cylinder.

| Material (phr) | Standard | Zeolite Na A | Zeolite Y |
|---|---|---|---|
| FKM type A | 100 | 100 | 100 |
| Magnesiun Oxide | 5.3 | 5.3 | 5.3 |
| Sodium Hydroxide | 3.5 | 3.5 | 3.5 |
| Carnauba Wax | 3.0 | 3.0 | 3.0 |
| Process Agent (Aflux 54) | 1.5 | 1.5 | 1.5 |
| Iron Oxide (Brown) | 0.7 | 0.7 | 0.7 |
| Iron Oxide (Red) | 0.1 | 0.1 | 0.1 |
| NaA (Zeolite) | 0.0 | 7.0 | 0.0 |
| NaY (Zeolite) | 0.0 | 0.0 | 7.0 |
| Precipitated Silica | 0.0 | 7.0 | 7.0 |
| (Aerosil R972) | | | |
| TOTAL | 114.1 | 128.1 | 128.1 |

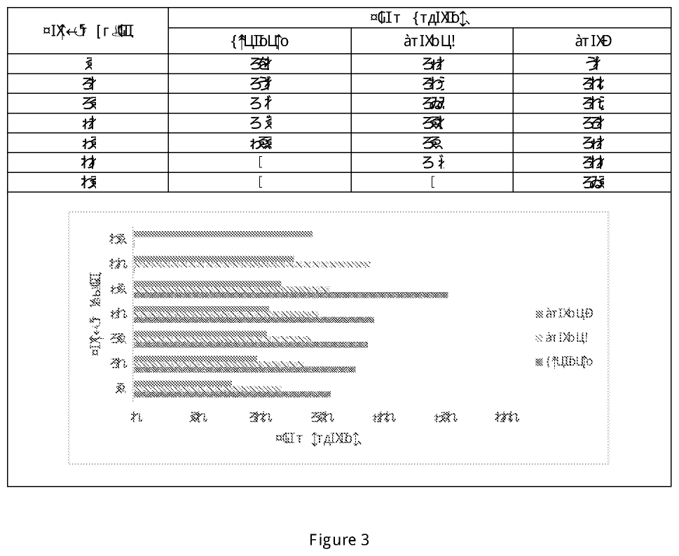

Rheological parameters were tested under ASTM D 2084 (170° C. —6 minutes) and results are shown in FIG. 3. Mechanical properties were tested under ASTM D 412 (rupture tension and elongation) and results are shown in FIG. 2. There a increase in the torque, for example, to 25 lbf/in from 255 seconds to 120 seconds (reducing 50% of time) when Zeo-Y was used. In addition, the rupture tension was increased by 40% with Zeo-Y. From this, it is clear that zeolites can activate the system that uses bisphenol (crosslinking agent), thereby reducing the time to get the same modulus (torque).

### Example 5: Preparation of Modified Additives

A. Preparation of the Si69 Modified Additives

Examples of modified materials: Zeolite A (NaA), Zeolite A nano (Nano_NaA) and soda lite zeolite (Sod).

The inorganic materials contain —OH groups on their surface for better interaction with the polymer and can be modified. Si69 is an organosilane typically used in the rubber industry for the purpose of improving the inorganic materials with the polymer base.

Si69® is a bifunctional, sulfur-containing organosilane for rubber applications in combination with white fillers containing silanol groups.

Si69® reacts with silanol groups of white fillers during mixing and with the polymer during vulcanization under formation of covalent chemical bonds. This imparts greater tensile strength, higher moduli, reduced compression set, increased abrasion resistance and optimized dynamic properties. Si69® is used in almost all fields of the rubber industry where silanol group containing white fillers are used and optimum technical properties are required.

Typical preparation of these organosilane modified materials (more specifically Si69 (Bis[3-(triethoxysilyl)propyl]polysulfide)), contemplates the dispersion of the zeolite in a solution of ethanol, or other compatible diluent, containing 0.02 mol Si69 (may be variable).

Aspect ratio: Load:Diluent:Organosilane (1 g: 10 mL: 0.1 mL).

The emulsion remains under stirring for 120 h at 40éC, after which the materials are filtered, heat treated in an oven at 130 éC/4 h, to effect the connections between the surface of the inorganic material and the Si69. From this procedure the materials are classified in #325 mesh sieve and packed in place protected from moisture. Ready for use.

B. Description of the Additives Tested

Performance tests were performed with the addition of different materials (additives) in a standard natural rubber compound. Table 2 shows the description of these additives, and the respective compound codes generated.

TABLE 2
Identification, description of the additives tested, and code of compounds generated.

| | | Compound |
|---|---|---|
| Identification | Description | code |
| Standard | Typical formulation based on natural rubber. | M1 |
| NaA_4phr | Zeolite NaA, used without modification. 4phr is the added content in | M2 |
| | Standard. | |
| NaA_8phr | Zeolite NaA, used without modification. 8phr is the added content in | M3 |
| | Standard. | |
| NaA_12phr | Zeolite NaA, used without modification. 12phr is the added content | M4 |
| | in Standard. | |
| NaA_16phr | Zeolite NaA, used without modification. 16phr is the added content | M5 |
| | in Standard. | |
| NaA_Si69 | Zeolite NaA, previously modified with Si69. | M6 |
| NaA + Si69 | Zeolite NaA, used without modification, with addition of Si69 in the | M7 |
| | step of blending the rubber compound. | |
| Sod | Zeolite Sodalite, used without modification. | M8 |
| Sod_Si69 | Zeolite Sodalite, previously modified with Si69. | M9 |
| Sod + Si69 | Zeolite Sodalite, used without modification, with addition of | M10 |
| | Si69 in the step of blending the rubber compound. | |
| Nano_NaA | Zeolite NaA nano, used without modification. | M11 |
| Nano_NaA_Si69 | Zeolite NaA nano, previously modified with Si69. | M12 |
| Nano_NaA + | Zeolite NaA nano, used without modification, with addition of | M13 |
| Si69 | Si69 in the step of blending the rubber compound. | |

Notes:
1. Evaluation of the amount of additive (without modification): 4, 8, 12 and 16 phr of the NaA additive were added to the standard formulation, producing the compounds: M2, M3, M4 and M5, respectively. In the other compounds 8 phr of the respective additives were added.
2. In the compounds M2, M3, M4, M5, M7, M8, M10, M11 and M13, the additive was acidified in the mixture without modification.
3. In compounds M6, M9 and M12, additive previously modified with S i69 was added.
4. In compounds M7, M10 and M13, additive was added without modification, with addition of S i69 in the step of mixing the rubber compound.

C. Blends

A traditional formulation of NR Rubber and rubbers using the compounds described herein were prepared as shown in Table 3, using Rubber to ngencia I rheometer (Haake R heomix 600P) to produce the Compound.

TABLE 2
Traditional formulation of NR Rubber (M1) and additives formulations (M2-M13)

| | Compound code | | | | | | |
|---|---|---|---|---|---|---|---|
| | M1 | M2 | M3 | M4 | M5 | M6 | M7 |
| | Identification of additives | | | | | | |
| | | | | | | | NaA + |
| Raw material | Standard | NaA_4phr | NaA_8phr | NaA_12phr | NaA_16phr | NaA_Si69 | Si69 |
| Natural Rubber | 27.7 | 27.7 | 27.7 | 27.7 | 27.7 | 27.7 | 27.7 |
| (SVR - 3L) | | | | | | | |
| Poli-isoprene | 50 | 50 | 50 | 50 | 50 | 50 | 50 |
| (SKI-3) | | | | | | | |
| Poly-stirene- | 22.3 | 22.3 | 22.3 | 22.3 | 22.3 | 22.3 | 22.3 |
| butadiene | | | | | | | |
| (1502) | | | | | | | |
| Carbon Black | 63.9 | 63.9 | 63.9 | 63.9 | 63.9 | 63.9 | 63.9 |
| (330) | | | | | | | |
| Filler (Sio2) | 25 | 25 | 25 | 25 | 25 | 25 | 25 |
| Aromatic Oil | 5.5 | 5.5 | 5.5 | 5.5 | 5.5 | 5.5 | 5.5 |
| (B26) | | | | | | | |
| Estearic Acid | 1.6 | 1.6 | 1.6 | 1.6 | 1.6 | 1.6 | 1.6 |
| Zinc Oxide | 2.7 | 2.7 | 2.7 | 2.7 | 2.7 | 2.7 | 2.7 |
| Flux Agent (q72) | 1.4 | 1.4 | 1.4 | 1.4 | 1.4 | 1.4 | 1.4 |
| Oxidation Agent | 1.1 | 1.1 | 1.1 | 1.1 | 1.1 | 1.1 | 1.1 |
| (TMQ) | | | | | | | |
| Ozone Agent | 1.6 | 1.6 | 1.6 | 1.6 | 1.6 | 1.6 | 1.6 |
| (7P) | | | | | | | |
| Sulfur | 0.88 | 0.88 | 0.88 | 0.88 | 0.88 | 0.88 | 0.88 |
| TMTD | 0.88 | 0.88 | 0.88 | 0.88 | 0.88 | 0.88 | 0.88 |
| TBBS | 0.88 | 0.88 | 0.88 | 0.88 | 0.88 | 0.88 | 0.88 |
| Test additive | 0 | 4.0 | 8.0 | 12.0 | 16.0 | 8.0 | 8.0 |
| Organosilane | 0 | 0 | 0 | 0 | 0 | 0 | 0.5 |
| Si_69 | | | | | | | |
| Total | 205.34 | 209.34 | 213.34 | 217.34 | 221.34 | 213.34 | 213.34 |

| | Compound code | | | | | |
|---|---|---|---|---|---|---|
| | M8 | M9 | M10 | M11 | M12 | M13 |
| | Identification of additives | | | | | |
| | | | Sod + | | | Nano_NaA + |
| Raw material | Sod | Sod_Si69 | Si69 | Nano_NaA | Nano_NaA_Si69 | Si69 |
| Natural Rubber | 27.7 | 27.7 | 27.7 | 27.7 | 27.7 | 27.7 |
| (SVR - 3L) | | | | | | |
| Poli-isoprene | 50 | 50 | 50 | 50 | 50 | 50 |
| (SKI-3) | | | | | | |
| Poly-stirene- | 22.3 | 22.3 | 22.3 | 22.3 | 22.3 | 22.3 |
| butadiene | | | | | | |
| (1502) | | | | | | |
| Carbon Black | 63.9 | 63.9 | 63.9 | 63.9 | 63.9 | 63.9 |
| (330) | | | | | | |
| Filler (Sio2) | 25 | 25 | 25 | 25 | 25 | 25 |
| Aromatic Oil | 5.5 | 5.5 | 5.5 | 5.5 | 5.5 | 5.5 |
| (B26) | | | | | | |
| Estearic Acid | 1.6 | 1.6 | 1.6 | 1.6 | 1.6 | 1.6 |
| Zinc Oxide | 2.7 | 2.7 | 2.7 | 2.7 | 2.7 | 2.7 |
| Flux Agent (q72) | 1.4 | 1.4 | 1.4 | 1.4 | 1.4 | 1.4 |
| Oxidation Agent | 1.1 | 1.1 | 1.1 | 1.1 | 1.1 | 1.1 |
| (TMQ) | | | | | | |
| Ozone Agent | 1.6 | 1.6 | 1.6 | 1.6 | 1.6 | 1.6 |
| (7P) | | | | | | |
| Sulfur | 0.88 | 0.88 | 0.88 | 0.88 | 0.88 | 0.88 |
| TMTD | 0.88 | 0.88 | 0.88 | 0.88 | 0.88 | 0.88 |
| TBBS | 0.88 | 0.88 | 0.88 | 0.88 | 0.88 | 0.88 |
| Test additive | 8.0 | 8.0 | 8.0 | 8.0 | 8.0 | 80 |
| Organosilane | 0 | 0 | 0.5 | 0 | 0 | 0.5 |
| Si_69 | | | | | | |
| Total | 213.34 | 213.34 | 213.34 | 213.34 | 213.34 | 213.34 |

We used zeolites like a raw material in a regular process and we observed that zeolites can activate the system (crosslink agent), reducing the time to get the same modulus (torque).

ASTM D 2084—Reological parameters (170éC—6 minutes).

D. Preparation of Standard Compound

The preparation of the standard compound was carried out in a cylinder-type mixer, in which the raw materials were processed in their proportions, as follows:

Natural Rubber (SVR-3L) −27.7 phr; Polyisoprene (SKI-3) −50 phr; Poly-styrene-butadiene (1502) −22.3 phr; Carbon Black (330) −63.9 phr, Filler (SiO2)=25 phr; Aromatic Oil (B26) 5.5 ppm; Estearic Acid 1.6 phr; Zinc Oxide-2.7 phr; Flux Agent (q72) −1.4 phr, Oxidation Agent (TMQ) 1.1 phr; Ozone Agent (7P) −1.6 phr; Sulfur-0.88 phr, TMTD-0.88 phr; TBBS −0.88 phr.

This standard was used as the basis for the addition of test additives.

Compound produced: M1

E. Preparation of Test Compounds Containing Test Additive without Modification or Addition of Si69

The preparation of the test compounds consisted of adding the test additives to the standard compound in due proportions. The blends were performed, a Haake Rheomix 600P mixing chamber at 80éC and at a speed of 60 rpm for 240 seconds (s). First the standard compound was added to the mixer, and homogenized for 60 s, after which the respective test additive was added, and homogenized for an additional 180 s.

Compound produced: M2, M3, M4, M5, M8, M11.

F. Preparation of Test Compounds Containing Test Additive Modified with Si69

The preparation of the test compounds consisted of adding the test additives to the standard compound in due proportions. The blends were performed in a Haake Rheomix 600P mixing chamber at 80éC and at a speed of 60 rpm for 240 seconds (s). First the standard compound was added to the mixer, and homogenized for 60 s, after which the respective test additive was added, and homogenized for an additional 180 s.

Compound produced: M6, M9 and M12

F. Preparation of Test Compounds Containing Additive without Further Modification Si69

The preparation of the test compounds consisted of adding the test additives to the standard compound in due proportions. The blends were performed in a Haake Rheomix 600P mixing chamber at 80ηC and at a speed of 60 rpm for 240 seconds (s). First the standard compound was added to the mixer, and homogenized for 60 s, after which the test additive plus the Si69 was added and homogenized for an additional 180 s.

Compound produced: M7, M10 and M13

### Example 4: Characterization

A. Rheometric Properties

Table 4 presents the values of Ts2, T90, ML and MH, extracted from the rheometric curves. Tests were performed in triplicate, P1, P2 and P3 represent the number of mixtures that were repeated and analyzed for each of the formulations.

TABLE 3
Ts2, T90, ML and MH, extracted from the rheometric curves.

| | | | | | | | | | | | | | T90 St |
|---|---|---|---|---|---|---|---|---|---|---|---|---|---|
| | ts2 (s) | | | T90 (s) | | | ML (dNm) | | | MH (dNm) | | | standard |
| | P1 | P2 | P3 | P1 | P2 | P3 | P1 | P2 | P3 | P1 | P2 | P3 | deviation |
| M1 | 49 | 53 | 56 | 77 | 80 | 85 | 5.3 | 5.4 | 5.3 | 25.4 | 20.4 | 20.1 | 0.0535 |
| M2 | | | 46 | | | 72 | | | 5.3 | | | 21.5 | |
| M3 | 37 | 33 | 35 | 58 | 57 | 58 | 5.7 | 5.9 | 5.8 | 24.3 | 22.3 | 23 | 0.0082 |
| M4 | | | 34 | | | 56 | | | 6 | | | 23.3 | |
| M5 | | | 36 | | | 57 | | | 5.5 | | | 21.4 | |
| M6 | 45 | 34 | 43 | 67 | 54 | 66 | 6.1 | 6 | 5.3 | 23.4 | 22.8 | 21.4 | 0.0993 |
| M7 | | | 43 | | | 65 | | | 5.4 | | | 19.4 | |
| M8 | 47 | 47 | 49 | 69 | 70 | 76 | 6 | 5.7 | 5.7 | 24.1 | 21.2 | 23 | 0.0497 |
| M9 | 49 | 50 | 47 | 73 | 76 | 70 | 5.8 | 5.3 | 5.3 | 23.6 | 20.4 | 21.1 | 0.0411 |
| M10 | | | 49 | | | 77 | | | 5.2 | | | 20.6 | |
| M11 | 43 | 38 | 52 | 62 | 60 | 75 | 6.2 | 6.2 | 5.9 | 24.7 | 22 | 18.2 | 0.1096 |
| M12 | 34 | 27 | 35 | 53 | 46 | 60 | 7.1 | 6.9 | 6.7 | 26.6 | 23 | 23.6 | 0.0939 |
| M13 | | | 46 | | | 72 | | | 5.8 | | | 21.9 | |

Note:
*ts2 is scorch time for viscosity to rise 2 units above ML;
*T90 is the time for the torque to increase to: 90/100(MH E ML) + ML;
*ML is the minimum torque;
*MH is the highest torque.

By performing an analysis of the standard deviation, a significant variation in the T90 value of compound M12 is observed when compared to M1 (standard).

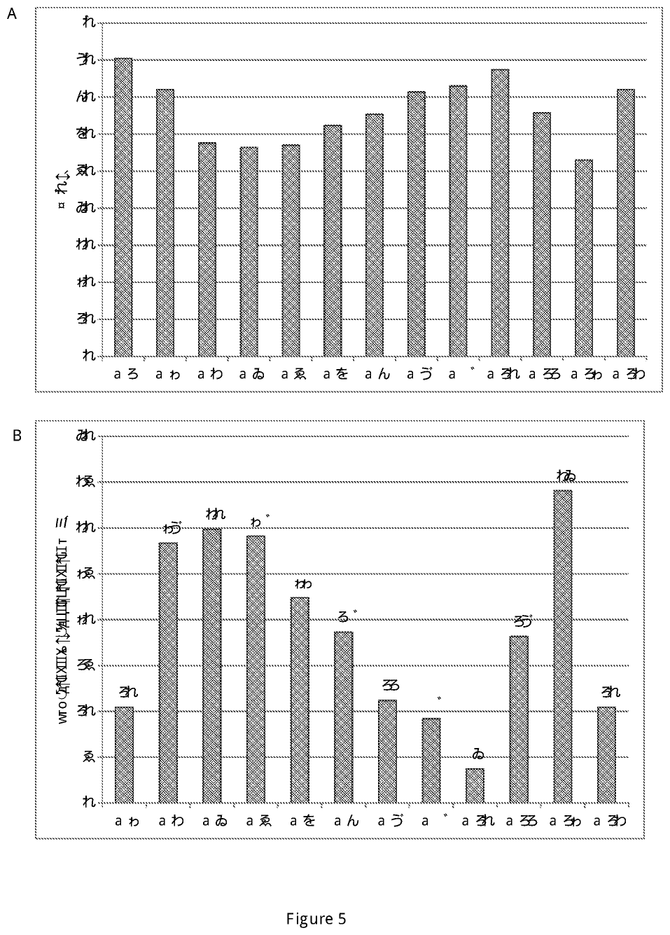

Significant variations of mean values were observed for T90. FIG. 5A shows that compound M12 showed the lowest T90, representing a curing time reduction of approximately 34% (FIG. 5B) compared to M1 (standard).

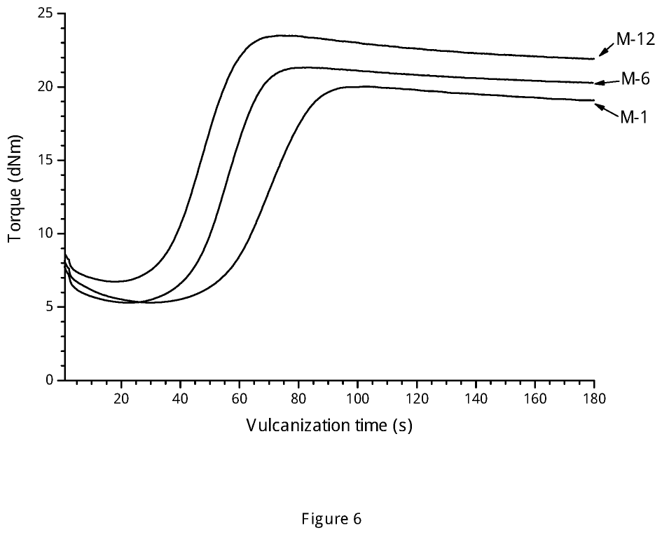

The reduction in curing time can best be observed in the rheometric curve, FIG. 6, which shows the curves of the compounds MI, M6 and M12. M1 (standard compound); M6 (Si69 modified NaA zeolite) and M12 (Si69 nano modified Zeolite NaA).

As compared to M1 (standard compound), it is easy to observe that addition of Si69 nano-modified NaA zeolite generates a minimum torque increase, probably due to a greater interaction with the polymer matrix, as well as a better dispersion in the nano polymer matrix particles.

B. Mechanical Properties

Physical-mechanical properties such as hardness, tension, stretching and abrasion, are evaluated in the main compounds produced. Evaluating Table 5, we have seen that the addition of the additives does not detract from its performance, with occasional improvements.

TABLE 4
Physical-mechanical properties of the compounds.

| | | | | | | | M7 |
|---|---|---|---|---|---|---|---|
| | M1 | M2 | M3 | M4 | M5 | M6 | NaA + |
| Ensaios | Standard | NaA_4phr | NaA_8phr | NaA_12phr | NaA_16phr | NaA_Si69 | Si69 |
| Hardness | 75 | 72 | 73 | 76 | 76 | 75 | 72 |
| (Shore A) | | | | | | | |
| Tensile stress | 43 | — | 39.6 | — | — | 40.7 | — |
| (Mpa) | | | | | | | |
| Elongation at | 271 | — | 313 | — | — | 267 | — |
| rupture (%) | | | | | | | |
| Abrasion | 100 | — | 104 | — | — | 102 | — |
| (ARI-%) | | | | | | | |

| | | | M10 | | | M13 |
|---|---|---|---|---|---|---|
| | M8 | M9 | Sod + | M11 | M12 | Nano_NaA + |
| Ensaios | Sod | Sod_Si69 | Si69 | Nano_NaA | Nano_NaA_Si69 | Si69 |
| Hardness | 74 | 76 | 72 | 75 | 74 | 73 |
| (Shore A) | | | | | | |
| Tensile stress | 41.7 | 39.9 | — | 42.4 | 41.8 | — |
| (Mpa) | | | | | | |
| Elongation at | 304 | 284 | — | 343 | 292 | — |
| rupture (%) | | | | | | |
| Abrasion | 103 | 103 | — | 97 | 95 | — |
| (ARI-%) | | | | | | |

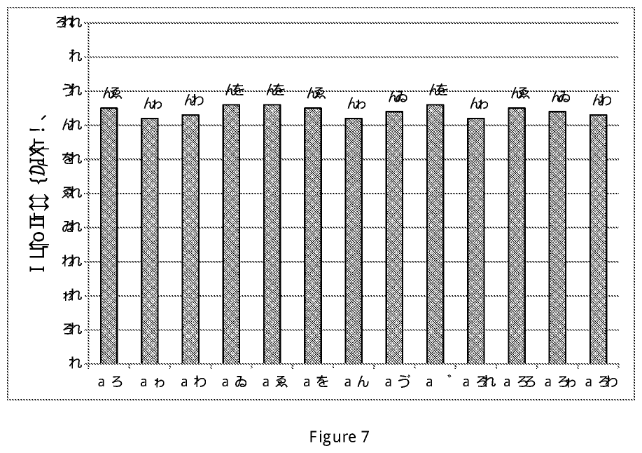

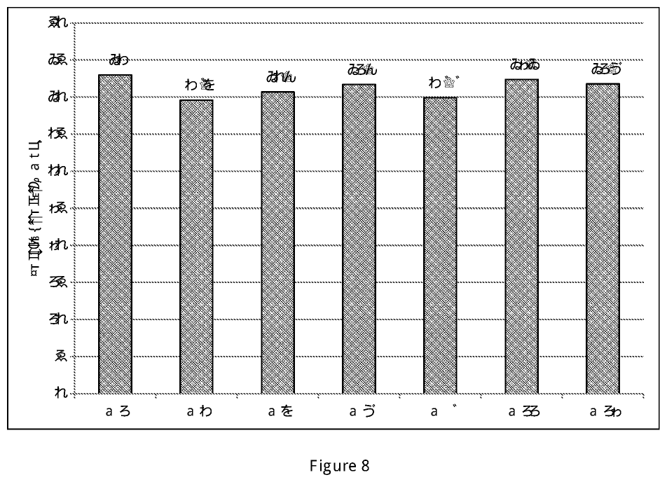

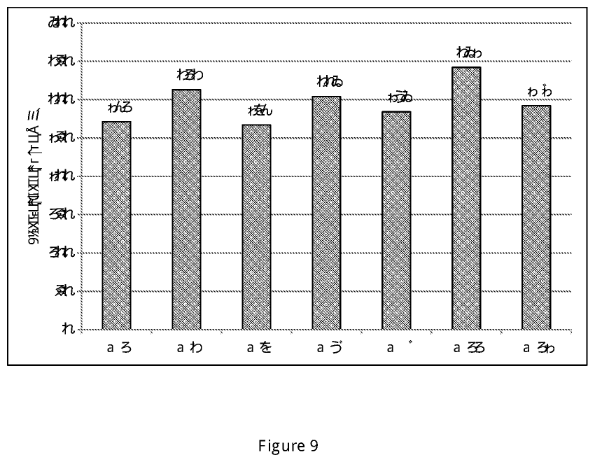

The hardness of the compounds, as shown in FIG. 7, is kept stable. The tensile strength, as shown in FIG. 8, and elongation at rupture, as shown in FIG. 9, present small variation, and for M12, which showed a promising reduction in vulcanization time, these properties are maintained stable when compared to MI.

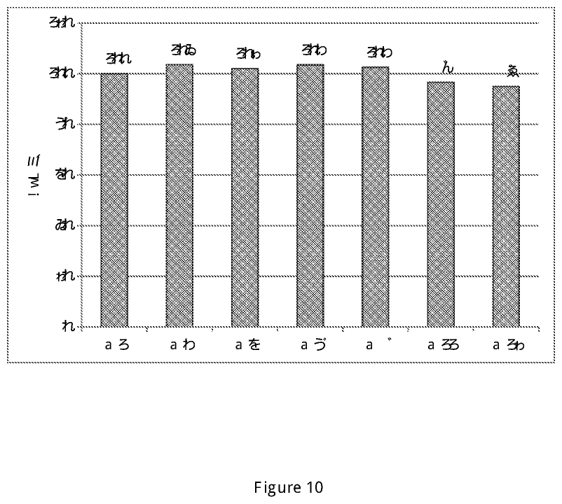

A significant improvement was observed in the abrasion data, as shown in FIG. 10, when added to zeolite NaA nano. This improvement is due to the fact that the zeolite particles will be in the nano size, improving the distribution in the polymer matrix, without creating agglomerate domains, improving abrasion resistance.

What is claimed is:

1. A nanostructured porous catalyst for rubber vulcanization, the catalyst comprising a high surface area.

2. The catalyst of claim 1, wherein the catalyst is a zeolite.

2a. The catalyst of claim 2, wherein the zeolite is selected from the group consisting of ZSM-5, A, X, Y, high silica zeolite, soda lite, modernite, clinoptilolite, faujasite, bentonite, erionite, and combinations thereof.

3. The catalyst of claim 1 or 2, wherein the catalyst is a mesoporous compound.

3a. The catalyst of claim 3, wherein the mesoporous compound is selected from the group consisting of SBA-15, MCM-48, SBA-1, SBA-6, SBA-16, FDU-2, KIT-S, MCM-41 and combinations thereof.

3b. The catalyst of any one of claims 1 to 3a, wherein the catalyst is modified with an organosilane.

3c. The catalyst of claim 3b, wherein the organosilane is selected from the group consisting of:
XIAMETER÷OFS-6070 Silane Methyl Methoxy Methyltrimethoxysilane
Dow Corning÷1-6383 Silane Methyl Ethoxy Methyltriethoxysilane
XIAMETER÷OFS-6194 Silane Methyl Methoxy Dimethyldimethoxysilane
Dow Corning÷Z-6265 Silane Propyl Methoxy Propyltrimethoxysilane
XIAMETER÷OFS-2306 Silane i-Butyl Methoxy Isobutyltrimethoxysilane
XIAMETER÷OFS-6124 Silane Phenyl Methoxy Phenyltrimethoxysilane
XIAMETER÷OFS-6341 Silane n-Octyl Ethoxy n-Octyltriethoxysilane
Dow Corning÷Z-6011 Silane Amino Ethoxy Aminopropyltriethoxysilane
XIAMETER÷OFS-6020 Silane Amino Methoxy Aminoethylaminopropyltrimethoxysilane
XIAMETER÷OFS-6094 Silane Amino Methoxy Aminoethylaminopropyltrimethoxysilane (high purity)
Dow Corning÷Z-6137 Silane Amino-Aminoethylaminopropylsiloxane oligomers (aq)
XIAMETER÷OFS-6032 Silane Vinyl-benzyl-amino Methoxy Vinylbenzylated aminoethylaminopropyltrimethoxysilane
XIAMETER÷OFS-6224 Silane Vinyl-benzyl-amino Methoxy Low CI version of XIAMETER÷OFS-6032 Silane
Dow Corning÷Z-6028 Silane Benzylamino Methoxy Benzylated-aminoethylaminopropyltrimethoxysilane
XIAMETER÷OFS-6030 Silane Methacrylate Methoxy g-Methacryloxypropyltrimethoxysilane
XIAMETER÷OFS-6040 Silane Epoxy Methoxy g-Glycidoxypropyltrimethoxysilane
XIAMETER÷OFS-6076 Silane Chloropropyl Methoxy g-Chloropropyltrimethoxysilane
Dow Corning÷Z-6376 Silane Chloropropyl Ethoxy g-Chloropropyltriethoxysilane
Dow Corning÷Z-6300 Silane Vinyl Methoxy Vinyltrimethoxysilane
XIAMETER÷OFS-6075 Silane Vinyl Acetoxy Vinyltriacetoxysilane
Dow Corning÷Z-6910 Silane Mercapto Ethoxy Mercaptopropyltriethoxysilane
XIAMETER÷OFS-6920 Silane Disulfido Ethoxy Bis-(triethoxysilylpropyl)-disulfide
XIAMETER÷OFS-6940 Silane Tetrasulfido Ethoxy Bis-(triethoxysilylpropyl)-tetrasulfide
Dow Corning÷Z-6675 Silane Ureido Methoxy g-Ureidopropyltriethoxysilane
XIAMETER÷OFS-6106 Silane Epoxy/melamine Methoxy Epoxy silane modified melamine resin
Bis[3-(triethoxysilyl)propyl]polysulfide (Si69⁺)

[symbol]

4. The catalyst of any one of claims 1 to 3c, comprising a crosslinking agent adsorbed to the catalyst.

4a. The catalyst of claim 3, wherein the crosslinking agent is selected from the group consisting of sulfur, sulfur compounds e.g. 4,4-dithiomorpholine; organic peroxides e.g. dicumyl peroxide; nitroso compounds e.g. p-dinitrosobenzene, bisazides, polyhydrosilanes, metal oxides bisphenols, such as bisphenol A, and combinations thereof.

5. The catalyst of claim 4, wherein the crosslinking agent is sulfur, such as rhombic sulfur.

5a. The catalyst of any one of claims 1 to 5, wherein the catalyst assists in positioning the crosslinking agent near a carbon atom in the rubber.

5b. The catalyst of any one of claims 1 to 5a, comprising an activator adsorbed to the catalyst.

5c. The catalyst of claim 5b, wherein the activator is thermally conductive.

5d. The catalyst of claim 5c, wherein the activator is selected from the group consisting of:
Aluminum, Antimony, Beryllium, Bismuth, Cadmium, Calcium, Chromium, Cobalt, Copper, Gold, Iron (, [symbol] , ∴), Lead, Magnesium, Manganese (, [symbol] , ∴), Mercury (liquid), Molybdenum, Nickel (, [symbol] ), Palladium, Platinum, Potassium, Rhodium, Silicon, Silver, Sodium, Thorium, Titanium, Tungsten, Vanadium, Zinc, Al₂O₃, B₂O₃, CaO, Cr₂O₃, CuO, Fe₂O₃, Fe₃O₄, PbO, PbO₂, MgO, NiO, SiO₂ quartz, SiO₂ quartz [symbol] , SiO₂ cristobalite, SiO₂ cristobalite [symbol] , TiO, U₃O₈, ZnO, ZrO₂, AIF₃, CaF₂, KF, NaF, and/or a member of the following table:
Condutividade Térmica

| | Condutividade |
|---|---|
| Material | térmica (W/mK) |
| Carbono (nanotubos) | 6000 |
| Grafite pirolitico (HOPG) | 1500 |
| Diamante | 1000 |
| Prata (Ag) | 426 |
| Cobre (Cu) | 380 |
| Ouro (Au) | 318 |
| Aluminio (Al) | 230 |
| Carbeto de silicio (SiC) | 200 |
| Tungst\tilde{e}nio (W) | 178 |
| Silicio (Si) | 148 |
| Zinco (Zn) | 112 |
| Latão (70Cu—30Zn) | 109 |
| Niquel (Ni) | 88.00 |
| Ferro (Fe) | 80.30 |
| Bronze (90Cu, 10Al) | 52.00 |
| Solda estanho/chumbo | 50.21 |
| (60Sn/40Pb) | |
| Aço | 50.20 |
| Safira (SiO2) | 41.00 |
| Chumbo (Pb) | 34.70 |
| Alumina (Ceràmica - Al2O3) | 30.00 |
| Titânio (Ti) | 21.00 |
| Mercúrio (Hg) | 8.30 |
| Basalto | 3.50 |
| Arenito (Pedra grês) | 1.60 |
| Gelo | 1.60 |
| Vidro borossilicato | 1.40 |
| Silica (SiO2) | 1.38 |
| Vidro comum | 1.00 |
| Concreto | 0.800 |
| Água | 0.610 |
| Polietileno alta densidade | 0.500 |
| Papel | 0.330 |
| Glicenna | 0.284 |
| Polipropileno | 0.250 |
| Teflon | 0.250 |
| Etilenoglicol | 0.240 |
| PVC | 0.200 |
| PET (Mylar) | 0.176 |
| Epóxi | 0.160 |
| Óleo de carnauba | 0.160 |
| Baquelite | 0.150 |
| Óleo mineral para transformadores | 0.144 |
| Óleo Lubrax | 0.135 |
| Madeira (compensado) | 0.120 |
| Poliamida (Kapton) | 0.120 |
| Vermiculita | 0.050 |
| Lã de vidro ou de rocha | 0.045 |
| Feltro | 0.040 |
| Poliestreno expandido (Isopor) | 0.040 |
| Cortiça | 0.039 |
| Ar | 0.026 |
| Poliuretano (espuma) | 0.024 |

6. The catalyst of any one of claims 1 to 3, wherein the catalyst is free of an adsorbed component.

6a. The catalyst of any one of claims 1 to 6, wherein the rubber is selected from the group consisting of natural rubber (NR), polyisoprene rubber (IR), styrene-butadiene rubber (SBR), polybutadiene rubber (BR), nitrile rubber (NBR), butyl rubber (IIR), brominated isobutylene-isoprene copolymers with bromine contents of 0.1 to 10 wt. % (BIIR), chlorinated isobutylene-isoprene copolymers with chlorine contents of 0.1 to 10 wt. % (CIIR), hydrogenated or partially hydrogenated nitrile rubber (NBR, HNBR, HSN), styrene-butadiene-acrylonitrile rubber (SNBR), styrene-isoprene-butadiene rubber (SIBR), polychloroprene (neoprene) (CR), chlorosulfonated polyethylene (CSM), epichiorohydrin rubber (ECH, ECO), ethylene propylene diene monomer (EPDM), ethylene propylene rubber (EPR), fluoroelastomer (FKM), perfluoroelastomer (FFKM), polyacrylate rubber (ACM), polysulfide rubber (PSR), sanifluor, silicone rubber (SiR), chlorinated polyethylene (CM), and combinations thereof.

6b. Si69-modified Zeolite NaA nano (designated M12).

7. A rubber composition comprising the catalyst of any one of claims 1 to 6b.

8. The rubber composition of claim 7, wherein the rubber composition is vulcanized.

9. The rubber composition of claim 8, wherein the rubber composition further comprises lignin.

9a. The rubber composition of claim 9, wherein the lignin is organosilane-modified.

9b. The rubber composition of any one of claims 7 to 9a, wherein the composition further comprises a surfactant.

9c. The rubber composition of claim 9b, wherein the surfactant comprises CTAB.

9d. The rubber composition of any one of claims 7 to 9c, wherein the rubber composition comprises improved properties of rupture, elongation, and/or abrasion as compared to a rubber composition without the catalyst.

10. A tire comprising the rubber composition of any one of claims 7 to 9a.

11. A method of vulcanizing rubber, the method comprising catalyzing the vulcanizing with the catalyst of any one of claims 1 to 6a.

11a. The method of claim 11, wherein the method results in an increase in the speed of vulcanization as compared to a method without the catalyst.

11b. The method of claim 11a, wherein the speed of vulcanization is increased due to an increase in the rate of cross-linking.

11c. The method of claim 11a or 11b, wherein the ts2 and/or t90 times are reduced as compared to a method without the catalyst.

11d. The method of any one of claims 11 to 11c, wherein the method results in a rubber comprising improved properties of rupture, elongation, and/or abrasion.

12. An organosilane for rubber vulcanization, the organosilane comprising an organosilane-modified lignin.

13. The organosilane of claim 12, wherein the organosilane modification is selected from the group consisting of:
XIAMETER÷OFS-6070 Silane Methyl Methoxy Methyltrimethoxysilane
Dow Corning÷1-6383 Silane Methyl Ethoxy Methyltriethoxysilane
XIAMETER÷OFS-6194 Silane Methyl Methoxy Dimethyldimethoxysilane
Dow Corning÷Z-6265 Silane Propyl Methoxy Propyltrimethoxysilane
XIAMETER÷OFS-2306 Silane i-Butyl Methoxy Isobutyltrimethoxysilane
XIAMETER÷OFS-6124 Silane Phenyl Methoxy Phenyltrimethoxysilane
XIAMETER÷OFS-6341 Silane n-Octyl Ethoxy n-Octyltriethoxysilane
Dow Corning÷Z-6011 Silane Amino Ethoxy Aminopropyltriethoxysilane
XIAMETER÷OFS-6020 Silane Amino Methoxy Aminoethylaminopropyltrimethoxysilane
XIAMETER÷OFS-6094 Silane Amino Methoxy Aminoethylaminopropyltrimethoxysilane (high purity)
Dow Corning÷Z-6137 Silane Amino-Aminoethylaminopropylsiloxane oligomers (aq)
XIAMETER÷OFS-6032 Silane Vinyl-benzyl-amino Methoxy Vinylbenzylated aminoethylaminopropyltrimethoxysilane
XIAMETER÷OFS-6224 Silane Vinyl-benzyl-amino Methoxy Low CI version of XIAMETER÷OFS-6032 Silane
Dow Corning÷Z-6028 Silane Benzylamino Methoxy Benzylated-aminoethylaminopropyltrimethoxysilane
XIAMETER÷OFS-6030 Silane Methacrylate Methoxy g-Methacryloxypropyltrimethoxysilane
XIAMETER÷OFS-6040 Silane Epoxy Methoxy g-Glycidoxypropyltrimethoxysilane
XIAMETER÷OFS-6076 Silane Chloropropyl Methoxy g-Chloropropyltrimethoxysilane
Dow Corning÷Z-6376 Silane Chloropropyl Ethoxy g-Chloropropyltriethoxysilane
Dow Corning÷Z-6300 Silane Vinyl Methoxy Vinyltrimethoxysilane
XIAMETER÷OFS-6075 Silane Vinyl Acetoxy Vinyltriacetoxysilane
Dow Corning÷Z-6910 Silane Mercapto Ethoxy Mercaptopropyltriethoxysilane
XIAMETER÷OFS-6920 Silane Disulfido Ethoxy Bis-(triethoxysilylpropyl)-disulfide
XIAMETER÷OFS-6940 Silane Tetrasulfido Ethoxy Bis-(triethoxysilylpropyl)-tetrasulfide
Dow Corning÷Z-6675 Silane Ureido Methoxy g-Ureidopropyltriethoxysilane
XIAMETER÷OFS-6106 Silane Epoxy/melamine Methoxy Epoxy silane modified melamine resin
Bis[3-(triethoxysilyl)propyl]polysulfide (Si69⁺)

[symbol]

14. A rubber composition comprising the organosilane of claim 12 or 13.

15. The rubber composition of claim 14, wherein the rubber composition is vulcanized.

16. The rubber composition of claim 15, further comprising the catalyst of any one of claims 1 to 6a.

17. A tire comprising the rubber composition of any one of claims 14 to 16.
